(19) United States
(12) Patent Application Publication
(10) Pub. No.: US 2016/0071353 A1
(43) Pub. Date: Mar. 10, 2016

(54) CHART REPRESENTATION OF RESULTS IN GAMES OF CHANCE AND NEW METHODS OF GAMING USING SUCH CHART REPRESENTATIONS

(71) Applicants: Jerzy MUCHNICKI, East St. Kilda (AU); Avi BOUHADANA, Chonburi (TH)

(72) Inventors: Jerzy MUCHNICKI, East St. Kilda (AU); Avi BOUHADANA, Chonburi (TH)

(21) Appl. No.: 14/852,289

(22) Filed: Sep. 11, 2015

Related U.S. Application Data
(63) Continuation-in-part of application No. PCT/IB14/59745, filed on Mar. 13, 2014.

(51) Int. Cl. G07F 17/32; G07F 17/34

(52) U.S. Cl. CPC G07F 17/323; G07F 17/3293; G07F 17/34; G07F 17/326; G07F 17/3288

(57) ABSTRACT

Candlesticks are used to illustrate the results of a casino game. Candlestick 100a is representative of a house, banker or dealer win, indicated by the green, gray or light colored body. Candlestick 100b is representative of a player win, indicated by the red, black or dark colored body. Each candlestick is formed based on four parameters, “High,” “Low,” “Open,” and “Close.”, similar to those used in Forex trading bar or candlestick charts. Wicks, specifically the upper wick, and the lower wick, extend from the respective bodies. A candlestick chart is created to show the results trend of a particular game. A first candlestick of the first round of the game extends from a start aligned with the previous Close (C) of the last result candlestick. Each subsequent candlestick showing each new result as added accordingly to the chart.

### RELATED U.S. APPLICATIONS

The present application is a continuation-in-part application under 35 U.S. Code Section 120 and Section 365 (c) of International application PCT/IB14/59745 with an international filing date of 13 Mar. 2014, and entitled “CANDLESTICK AND BAR CHARTS REPRESENTATION FOR GAMES”, presently pending.

### STATEMENT REGARDING FEDERALLY SPONSORED RESEARCH OR DEVELOPMENT

Not applicable. cl REFERENCE TO MICROFICHE APPENDIX

Not applicable.

### BACKGROUND OF THE INVENTION

1. Field of the Invention

The present invention, in some embodiments thereof, relates to providing chart representations of results in games of chance via candlestick charts or bar charts, and new methods of gaming or gambling using such chart representations.

2. Description of Related Art Including Information Disclosed Under 37 CFR 1.97 and 37 CFR 1.98.

Contemporary casino games are typically only played by players against the house on a game by game basis. There is very little, if any side betting on the outcomes of trends when placing bets, to predict future win trends.

Some games, such as Baccarat, can be tracked with score cards, by a standard scoring system. However, the scoring system is complicated and the scorecards are difficult to read. Moreover, the complexity of the scoring system makes pattern analysis from these scorecards limited to very few players

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### SUMMARY OF THE INVENTION

According to a first aspect, the present invention provides a computer-implemented method for displaying results in a game of chance as a chart, the method comprising:
a) transforming the result of a round of the game into a candlestick or bar for the chart,
b) adding the candlestick or bar for the round to the chart,
c) repeating steps (a) and (b) for each round of the game.

In one preferred embodiment, each candlestick or bar comprises a body having a height extending from a parameter Open to a parameter Close.

In another preferred embodiment, each candlestick or bar to be added is positioned laterally adjacent the preceding candlestick or bar, and the parameter Open of a candlestick or bar to be added is horizontally aligned with the parameter Close of the preceding candlestick or bar.

In another preferred embodiment, each body extends vertically and oriented in an upwards or downwards direction relative to the parameter Close of the preceding candlestick or bar, the direction being determined by the winning result of the game.

In another preferred embodiment, each candlestick or bar body can include upper and/or lower wicks extending from the body, the lower wick extending from a parameter Low and the upper wick extending from a parameter High.

In another preferred embodiment, for a Baccarat game, the height of the body is equal to a pip value of a winning Banker or Player hand.

In another preferred embodiment, for a Baccarat game, a total candlestick or bar wick height is the sum of pip values of the Player card values plus the sum of pip values of the Banker card values, wherein the body extends from the junction point of the Banker and Player pips and along the winning hand wick for a length of the winning hand value pips.

In another preferred embodiment, the body is provided with a respective predetermined color to indicate a Banker or Player win.

In another preferred embodiment, for a Baccarat game, the body extends upwardly for a Banker win and downwardly for a Player win.

In another preferred embodiment, for a Roulette game, the height of the body is determined by the number of slots a Roulette ball has traveled on the Roulette wheel from the previous number result to the present number result.

In another preferred embodiment, if the present number result is zero, the candlestick body has zero height.

In another preferred embodiment, for a Roulette game, the game options of High/Low, Even/Odd, or Black/Red are provided, wherein the body extends upwardly for results High, Even, or Black, and the body extends downwardly for results Low, Odd, or Red.

In another preferred embodiment, the body is provided with a respective predetermined color to indicate a High/Even/Black or Low/Odd/Red result.

In another aspect, the present invention provides a computer-implemented method of gaming, the method comprising:
displaying the results of rounds in a game of chance as a chart according to the method of the above,
a player selecting a number of rounds to play of the game,
a player selecting to bet on trend-up or trend-down from a starting level being level with a Close of the preceding candlestick or bar body prior to game start,
determining a finishing level at game finish being level with a Close of the final candlestick or bar body after the number of rounds, and
wherein the vertical position of the finishing level relative to the starting level determines a win or loss for the Player.

In another preferred embodiment, the method comprises an early exit feature, wherein a part profit or part loss is offered to the Player to terminate the game prior to game finish.

In another preferred embodiment, the part profit or part loss is calculated from the relative position between the starting level and a current level being level with a Close of the latest candlestick or bar body.

In another aspect, the present invention provides a computer-implemented method of gaming, the method comprising:
displaying the results of rounds in a game of chance as a chart according to the method of the above,
a player selecting to bet on trend-up or trend-down from a starting level being level with a Close of the preceding candlestick or bar body prior to game start,
a player selecting upper and lower limits of a trend chart,
wherein a candlestick or bar body during the game crossing either the upper or lower limit terminates the game and determines a win or loss for the Player.

In another preferred embodiment, the method comprises an early exit feature, wherein a part profit or part loss is offered to the Player to terminate the game prior to game finish.

In another preferred embodiment, the part profit or part loss is calculated from the relative position between the starting level and a current level being level with a Close of the latest candlestick or bar body.

In another aspect, the present invention provides a computer-implemented method for displaying at least one result in a game of chance, the method comprising:
(a) transforming the result of a round of the game into a candlestick or bar for a chart.

In one preferred embodiment, the candlestick or bar comprises a body having a height extending from a parameter Open to a parameter Close, the height of the body being determined by the winning result of the game.

According to an aspect of some embodiments of the present invention there is provided a computer-implemented method for tracking trends in card games. The method comprises: obtaining the results of a plurality of individual sessions of a card game, and the cards for the plurality of the individual sessions from a single pool of cards including a fixed amount of cards; transforming the results of each individual session into a bar for a bar chart, the bar defined by a plurality of parameters associated with the values assigned to the cards in accordance with the rules of the card game; and, adding each bar for each successive individual session to a bar chart in a consecutive order corresponding to the order of each individual session.

Optionally, the bar includes a candlestick and the bar chart includes a candlestick chart.

Optionally, the each individual session of the plurality of sessions includes a baccarat session.

Optionally, the each individual session of the plurality of sessions includes a blackjack session.

Optionally, the each individual session of the plurality of sessions includes a Hi Lo session.

Optionally, the parameters include values for Open, Close, High and Low.

Optionally, the results are for individual players and the bar charts are for each individual player for the card game.

Optionally, the results are for individual players and the candlestick charts are for each individual player for the card game.

Some embodiments of the present invention are directed to a computerized system for tracking trends in card games. The computerized system comprises a storage medium for storing computer components; and, a processor for executing the computer components. The computer components comprise: a first component for obtaining the results of a plurality of individual sessions of a card game, and the cards for the plurality of the individual sessions from a single pool of cards including a fixed amount of cards; a second component for transforming the results of each individual session into a bar for a bar chart, the bar defined by a plurality of parameters associated with the values assigned to the cards in accordance with the rules of the card game; and, a third component for adding each bar for each successive individual session to a bar chart in a consecutive order corresponding to the order of each individual session.

Optionally, the bar includes a candlestick and the bar chart includes a candlestick chart.

Optionally, the each individual session of the plurality of sessions is selected from the at least one of: a baccarat session, a blackjack session and a HiLo session.

Optionally, the parameters include values for Open, Close, High and Low.

Optionally, the results are for individual players and the bar charts are for each individual player for the card game.

Optionally, the results are for individual players and the candlestick charts are for each individual player for the card game.

Some embodiments of the present invention are directed to a computer usable non-transitory storage medium having a computer program embodied thereon for causing a suitable programmed system for tracking trends in card games, by performing the following steps when such program is executed on the system. The steps comprise: obtaining the results of a plurality of individual sessions of a card game, and the cards for the plurality of the individual sessions from a single pool of cards including a fixed amount of cards; transforming the results of each individual session into a bar for a bar chart, the bar defined by a plurality of parameters associated with the values assigned to the cards in accordance with the rules of the card game; and, adding each bar for each successive individual session to a bar chart in a consecutive order corresponding to the order of each individual session.

Optionally, the bar includes a candlestick and the bar chart includes a candlestick chart.

Optionally, the each individual session of the plurality of sessions is at least one of a baccarat session, a blackjack session and a HiLo session.

Optionally, the parameters include values for Open, Close, High and Low.

Optionally, the results are for individual players and the bar charts are for each individual player for the card game.

Optionally, the results are for individual players and the candlestick charts are for each individual player for the card game.

Some embodiments of the present invention are directed to a computer implemented method for tracking trends in games. The method comprises: obtaining the results of a plurality of individual sessions of a game; transforming the results of each individual session for each individual player of the game into a bar for a bar chart for the individual player, the bar defined by a plurality of parameters associated with the values assigned to the game components in accordance with the rules of the game; and, adding each bar for each successive individual session to a bar chart for the individual player, in a consecutive order corresponding to the order of each individual session.

Optionally, the bar includes a candlestick and the bar chart includes a candlestick chart.

Optionally, the parameters include values for Open, Close, High and Low.

Optionally, the game is a card game and the game components include cards.

Optionally, the cards for the plurality of the individual sessions of the card game are from a single pool of cards including a fixed amount of cards.

Optionally, the each individual session of the plurality of sessions of the card game is at least one of a baccarat session, a blackjack session and a HiLo session.

Optionally, the game is roulette and the game components include characters.

Optionally, the characters include numbers.

Some embodiments of the present invention are directed to a computerized system for tracking trends in games. The system comprises a storage medium for storing computer components, such as modules; and, a processor for executing the computer components. The computer components, comprise: a first component for obtaining the results of a plurality of individual sessions of a game; a second component for transforming the results of each individual session for each individual player of the game into a bar for a bar chart for the individual player, the bar defined by a plurality of parameters associated with the values assigned to game components in accordance with the rules of the game; and, a third component for adding each bar for each successive individual session to a bar chart for the individual player, in a consecutive order corresponding to the order of each individual session.

Optionally, the bar includes a candlestick and the bar chart includes a candlestick chart.

Optionally, the parameters include values for Open, Close, High and Low.

Optionally, the game is a card game and the game components include cards.

Optionally, the card game includes at least one of baccarat, blackjack, and HiLo.

Optionally, the game is roulette and the game components include characters.

Optionally, the characters include numbers.

Other aspects of the invention are also disclosed.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIGS. 1A and 1B are schematic views of diagrams of candlesticks for a candlestick chart in accordance with embodiments of the present invention;

FIGS. 2A and 2B are schematic views of diagrams of bars for a bar chart in accordance with embodiments of the present invention.

FIGS. 3A and 3B are schematic views of diagrams detailing candlestick formation in a Baccarat game in accordance with embodiments of the present invention.

FIGS. 4A and 4B are schematic views of diagrams detailing candlestick formation for a banker win in a Baccarat game, in accordance with embodiments of the present invention.

FIGS. 5A and 5B are schematic views of diagrams detailing candlestick formation for a player win in a Baccarat game, in accordance with embodiments of the present invention.

FIGS. 6A and 6B are schematic views of diagrams detailing candlestick formation for a tie in a Baccarat game, in accordance with embodiments of the present invention.

FIGS. 7A-7F are schematic views of candlestick charts showing the results of a series of sample baccarat games in accordance with embodiments of the present invention;

FIG. 8A is a schematic view of a diagram of an environment for a system in accordance with embodiments of the present invention.

FIG. 8B is a schematic view of a diagram of the architecture of a system in accordance with embodiments of the present invention.

FIG. 9 is flow diagram of a process in accordance with embodiments of the present invention.

FIG. 10 is a screen shot of an application software, web site or a web page which is an interactive display for a Baccarat game in accordance with embodiments of the present invention.

FIG. 11A-11C are schematic views of diagrams for candlesticks for Blackjack, in accordance with embodiments of the present invention.

FIG. 11D is a schematic view of an illustrative diagram for placing bets during a Blackjack game, in accordance with embodiments of the present invention.

FIG. 12A is a schematic view of an illustrative diagram for placing bets during a Hi Lo game, in accordance with embodiments of the present invention.

FIG. 12B and 12C are schematic views of diagrams for candlesticks for Hi Lo, in accordance with embodiments of the present invention.

FIG. 13A is a schematic view of a diagram for candlestick bodies for Roulette, in accordance with embodiments of the present invention.

FIG. 13B is a distance Matrix for the determining the bodies of FIG. 13A.

FIG. 13C is a diagram for candlestick wicks for Roulette, in accordance with embodiments of the present invention.

FIG. 13D is a distance Matrix for the determining the wicks of FIG. 13C.

FIG. 14 shows a chart showing the nominated up/down direction of the candlestick bodies from the previous Close, for each of the selected game options High/Low, Even/Odd, or Black/Red for a Roulette game.

FIG. 15 shows a schematic view of respective betting selection screens for game options High/Low, Even/Odd, or Black/Red for a Roulette game.

FIG. 16 shows screenshots of an example binary Roulette game, where (a) shows a betting screen, (b) shows a game start screen, (c) shows a game end screen, and (d) shows an early exit option screen.

FIG. 17 shows screenshots of an example FX Roulette game, where (a) shows a betting screen, (b) shows a game start screen, (c) shows a game end screen, (d) shows an early exit option screen and (e) shows a double profit betting screen.

### DETAILED DESCRIPTION OF THE DRAWINGS

It should be noted in the following description that like or the same reference numerals in different embodiments denote the same or similar features.

Throughout this document, references to directions, such as upward, downward, upper, lower, up, down, top, bottom, left, right, horizontal, vertical, perpendicular, and the like, are made. These directional references are to typical orientations for bars and candlesticks, and the bar charts and candlestick charts formed therefrom, with respect to their orientation on the paper on which the requisite drawing figure is displayed. These directional references are exemplary only, and not limiting in any way, as they are for description and explanation purposes.

The present invention, in some embodiments, is directed to systems and methods for administering and playing casino games, including managing the betting therefor, and translating the results of the sessions or rounds of the games into bar charts, such as candlestick charts, representative of trends and result patterns of the games. Individual bar charts are created for each individual game round or set of game rounds. The bar chart can comprise a standard bar chart or a candlestick chart. Alternatively, the trends can be shown as a line graph. The casino games may include card games, such as Baccarat, Black Jack, and Hi Lo, and other games, including numbers games, such as roulette.

The present invention, in embodiments thereof, now allows players to bet on casino games based on the trend of the game as indicated by the bar or candlestick chart or line chart for that casino game.

In order to produce the charts, with bars or candlesticks positioned therein, each game is played in sessions or rounds (the terms “rounds” and “sessions”, including singular forms thereof, being used interchangeably herein). The shape, dimension and positioning of each bar or candlestick (relative to its adjacent previous bar or candlestick) provides an indication of the aforementioned trend or pattern. After a round, certain number of rounds, or after a trend result is achieved, a game is considered complete and another game, begins. With card games, the cards for the sessions of the game are typically from a fixed or single pool, and only these cards are used for all of the sessions of the game.

The resultant bar charts, such a candlestick charts, in accordance with embodiments of the present invention, are easy to read and understand, as the charted trends are viewable in these bar charts as upward and downward movements. These upward and downward movements can indicate statistical information that is not available with conventional methods for analyzing card games and other games. As a result, the game players may benefit by applying existing technical analysis methods and indicators, identify patterns on the charts, and allow the player to potentially predict a new trend, a trend reversal, and the strength of such trends in an attempt to exploit those patterns for the greatest potential profit.

Additionally, according to some embodiments of the present invention, the charts of the present invention provide an efficient representation of the game history. This allows the players, those playing and not playing the game, to make quick decisions for betting and strategy. The charts produced in the present invention are used to provide new methods of gaming, being betting on a trend up or trend down, as further described below. The charts can however also be used in normal casino games to provide a new and interesting way of displaying the historical results of the casino game.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

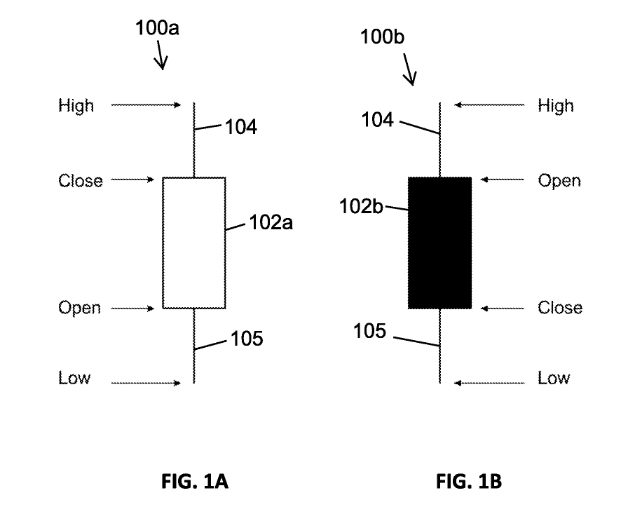

FIGS. 1A and 1B show exemplary candlesticks 100a (FIG. 1A), 100b (FIG. 1B), which define the candlesticks for card games used throughout this document. Candlestick 100a is representative of a house, banker or dealer win, indicated by the green, gray or light colored body 102a. Candlestick 100b is representative of a player win, indicated by the red, black or dark colored body 102b. Similar candlesticks are used for games based on Roulette as described below. Each candlestick is formed based on four parameters, “High,” “Low,” “Open,” and “Close.”, similar to those used in Forex trading bar or candlestick charts. Wicks, specifically the upper wick 104, and the lower wick 105, extend from the respective bodies 102a, 102b. Throughout this document, the candlesticks and bars are discussed in vertical orientations, with the “downward” direction being from the parameter “High” to the parameter “Low”, and the “upward” direction vice versa. Accordingly, for card based games, with house, banker or dealer win candlesticks (candles) 100a results, with the body 102a extending upward from the parameter “Open” to the parameter “Close”. In player win for card based games, candlesticks (candles) 100b, the body 102b extends downward, from the parameter “Open” to the parameter “Close.” Alternatively, these directions can be reversed for banker and player wins if desired for card based games.

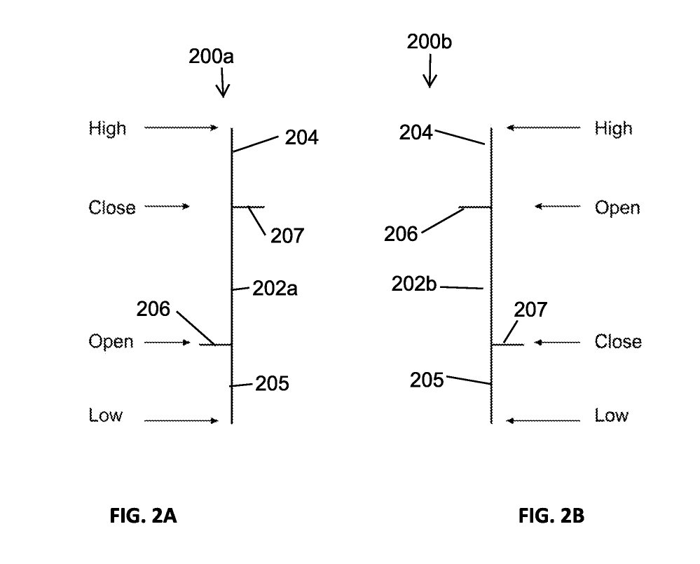

For card based games, FIGS. 2A and 2B are bars 200a, 200b, respectively, corresponding to the house, banker or dealer win 200a, and shown in FIG. 2A, and a player win 200b, shown in FIG. 2B. The bars 200a, 200b include upper 204 and lower 205 wicks, with the “Open” parameter being a protrusion 206 to the left, and the “Close” parameter being a protrusion 207 to the right. The bodies 202a, 202b, corresponding to the bodies 102a, 102b, detailed above, are defined along the length of the bar 200a, 200b, between the protrusions 206, 207, representing the “Open” and “Closed” parameters.

The present invention will now be described as applied to specific games. While certain games are discussed, this is exemplary only, as the present invention may be employed with other casino games, other games, card games and non-card games.

BACCARAT

A. Traditional Rules

The rules of Baccarat are, for example, described in “How To Play Baccarat,” by John Grochowski, available at, http://entertainment.howstuffworks.com/how-to-play-baccarat1.htm, (Grochowski), which is incorporated by reference in its entirety herein. In accordance with Grochowski, in Baccarat, the object is to bet on the two- or three-card hand that totals closer to nine. Tens and face cards all are worth zero points; all other cards are worth their face value, with the ace worth one point. If a total is more than 10, the second digit is the value of the hand. For example, a 9 and a 6, which total 15, make up a five-point hand.

Initially, two cards are dealt for each hand. The point totals determine whether either hand gets a third card. The player hand is completed first. A total of 8 or 9 is called a “natural,” and the player hand gets no more cards. In fact, unless the banker has a natural 9 or ties the natural 8, no further cards are drawn, and the naturals are automatic winners. The player also stands on totals of 6 or 7. On any other total, zero through 5, player draws a third card, unless banker has a natural, in which case the bank hand wins with no further draw.

Banker rules are a bit more complex. The banker also stands on 7, 8, or 9 and draws on 0, 1, or 2, but on other hands the banker's play is dependent on the value of the player's third card. Banker hits 3 unless the player's third card is an 8; hits 4 unless the player's third card is 1, 8, 9, or 10; hits 5 only if the player's third card is 4, 5, 6, or 7; and hits 6 only if the player's third card is 6 or 7.

Player Hand: When first two cards total:

| | |
|---|---|
| 1-2-3-4-5-10 | Draws a card |
| 6-7 | Stands |
| 8-9 | Natural -- Stands |

Banker Hand

| First two | Draws when player's | Stands when player's |
|---|---|---|
| cards total: | third card is: | third card is: |
| 3 | 1-2-3-4-5-6-7-9-10 | 8 |
| 4 | 2-3-4-5-6-7 | 1-8-9-10 |
| 5 | 4-5-6-7 | 1-2-3-8-9-10 |
| 6 | 6-7 | 1-2-3-4-5-8-9-10 |
| 7 | Stands | |
| 8-0 | Natural -- Stands | |
| 0-1-2 | Always draws | |

There are a few exceptions. A natural, as noted above, stops play with no further draws. If the player has one of its other two standing hands, 6 or 7, the banker stands on 6 as well as 7, 8, and 9.

Neither hand ever gets more than three cards. After the hands have been played out, the hand totaling closer to 9 wins. Winning bets are paid off at even money. Ties push, which means that neither hand, that of the banker or the player, wins nor loses.

Bets on Ties are allowed. Bettors also may wager that the two hands will finish with an equal number of points. Winning bets on ties pay off at 8-1. It is to be understood however that other rules of Baccarat can also be used.

B. User Interface and Chart Definitions

In Baccarat in embodiments of the present invention, the card values of the Banker and Player hands of a particular round is known as Pip Values or simply Pips. The Pips determine the height (from the parameter “High” to the parameter “Low”) of the candlestick 100, and the height (from the parameter “Open” to the parameter “Close”) of the body 102 for each candlestick 100. The Pips of each Banker and Player hand is the sum of the card values thereof—and these represent the length of the wick of each Banker and Player hand.

The height of the candlestick 100 is the sum total of the Banker and Player Pips. The height of the body 102 is the winning hand value (Final Value) of the Banker or Player hand.

The wicks thus represent the sum total of all cards dealt for the particular session. In the case of a tie, the candle does not have a body, but rather the wicks combine, with the tie represented by a perpendicular dash through the combined wicks. Examples are described below.

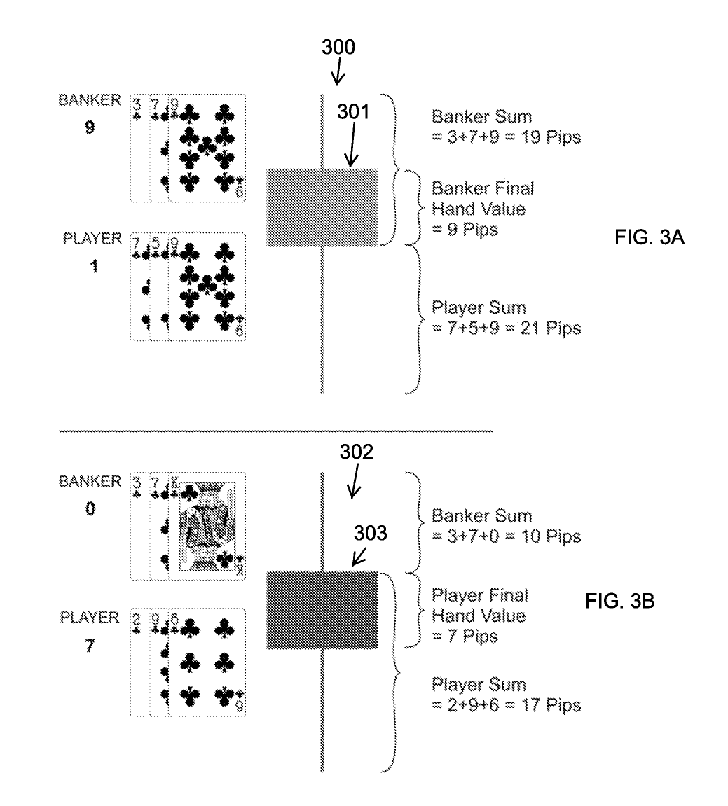

Turning to FIGS. 3A and 3B, a candle is built, representative of a single session of a Baccarat game. In FIG. 3A the Banker has won, as the sum of the three cards in his hand equals “19 Pips,” which is a final hand value of “9 Pips,” with the banker who has a final value of “9” or closest thereto being the winner. The player's cards add to a sum of “21 Pips,” with a final hand value of “1 Pip.” The candle 300 has a height of “40 Pips”, as:

40 Pips=19 Pips (Banker Sum)+21 Pips (Player Sum).

The Banker Pips are represented at the upper portion of the candle 300 and the Player Pips are represented at the lower portion of the candle 300. The junction point of the Banker and Player Pips is designated as the parameter “Open”.

As the Banker won, the body 301 is green (or gray/light colour), and 9 Pips in length, these 9 Pips corresponding to the Banker's final hand value of 9 Pips. The body 301 extends upward from the 21st Pip from the bottom, for 9 Pips, as this is the first Pip of the 19 Pips attributable to the Banker. In other words, the body 301 extends from the parameter “Open”, along the winning hand wick (the Banker in this example), for a length of the winning hand value pips. The end of the body 301 is designated as the parameter “Close”.

In FIG. 3B the Player has won, as the sum of the three cards in his hand equals “17 Pips,” which is a final hand value of “7 Pips,”. The Banker's cards add to a sum of “10 Pips,” with a final hand value of “0 Pips.” The candle 302 has a height of “27 Pips”, as:

27 Pips=10 Pips (Banker Sum)+17 Pips (Player Sum).

As the Player won, the body 303 is red (or black/dark colour), and is 7 Pips in length, these 7 Pips corresponding to the Player's final hand value of 7 Pips. The body extends for 7 Pips downwards from the 10th Pip from the top, as this is the first Pip of the 17 Pips attributable to the Player.

As above, the body 303 extends from the parameter “Open” (the junction point between the upper Banker wick and the lower Player wick), along the winning hand wick (the Player in this example), for a length of the winning hand value pips.

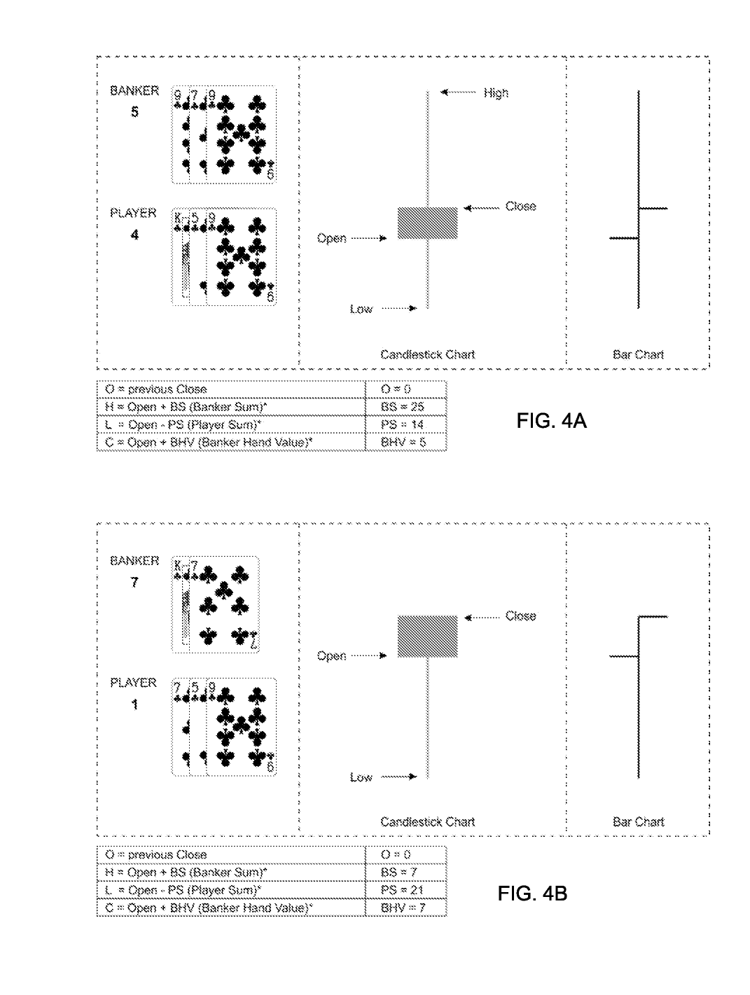

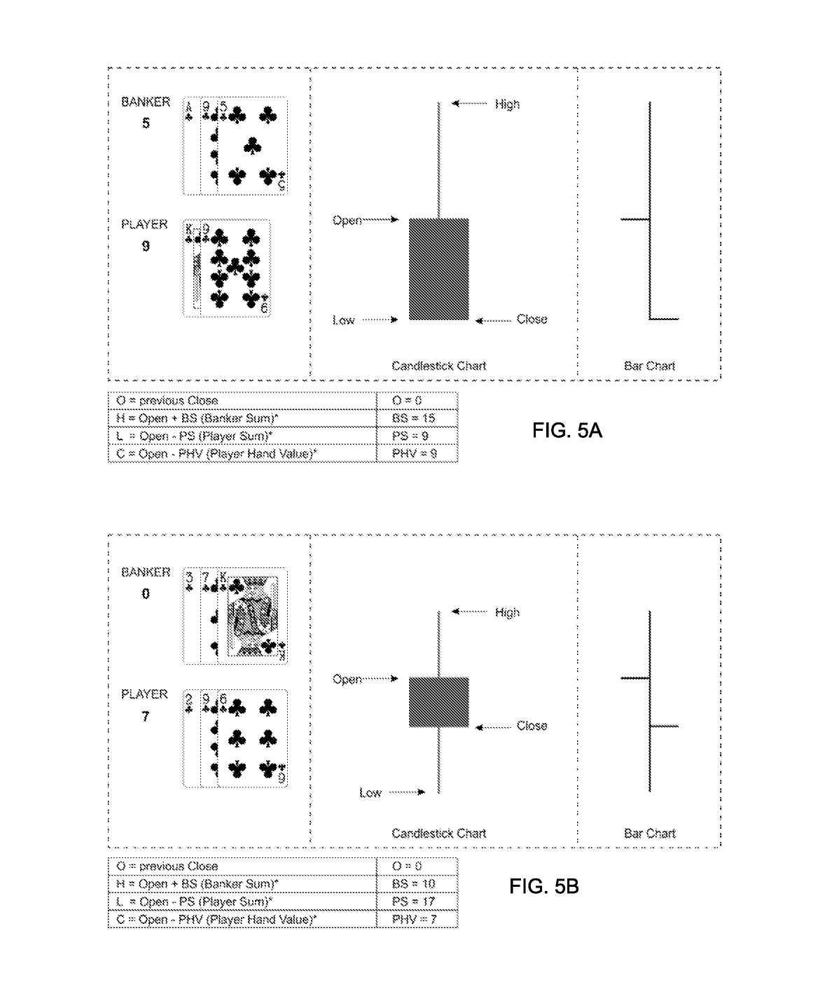

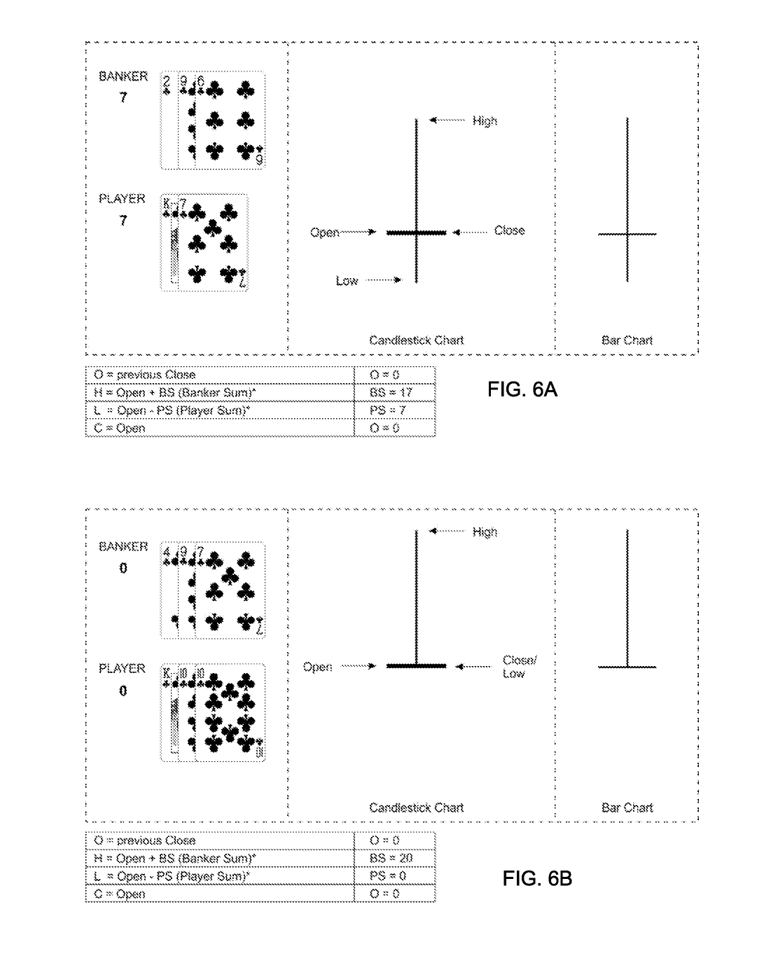

Attention is now directed to FIGS. 4A and 4B, detailing a Banker win, FIGS. 5A and 5B, detailing a Player Win, and FIGS. 6A and 6B detailing Ties between the Banker and the Player. The following formulas provide a method for transforming the card and hand values of a Baccarat Round (a round of play) into the parameters OPEN (O), HIGH (H), LOW (L), and CLOSE (C) necessary to form a Candlestick and/or a bar, for the respective candlestick and bar charts. Each card dealt to the Banker and Player is used in establishing the parameters, e.g., O, H, L, C, for each Candlestick and/or bar.

C. Description of Variables and Examples

BS (Banker Sum) is the sum of all cards dealt to the Banker excluding any 10's or face cards (Jack (J), Queen (Q), King (K)) which have no (zero) value: for example, a hand consisting of 7, 6, K is worth 13 (13 Pips), or a hand consisting of 8, 7, 9 is worth 24 (24 Pips). Hence the BS values are 13 (13 Pips) and 24 (24 Pips) respectively.

PS (Player Sum) is the sum of all cards dealt to the Player excluding any 10's or face cards (J,Q,K) which have no (zero) value: As per BS example above. BHV (Banker Hand Value) is the final hand value as determined by the standard valuation of hands.

PHV (Player Hand Value) is the final hand value as determined by the standard valuation of hands.

In FIGS. 4A and 4B, where the outcome is a banker win, parameters are as follows:
Open (O)=previous Close (C) (this determines the positioning of the body of the candlestick/bar relative to the previous candlestick/bar as described below).

High(H)=Open(O)+BS(Banker sum)

Low(L)=Open(O)−PS(Player Sum)

Close(C)=Open(O)+BHV(Banker Hand Value)

Turning to FIG. 4A, the Banker hand, which is the winning hand, hence the green (or gray/light colour)body, extending upward from “Open” to “Close,” has a Banker Hand Value (final value) of 5 and a Banker Sum (total value) of 25 Pips (9+7+9=25). The player hand, which is the losing hand, has a Player Hand Value (final value) of 4, and a Player Sum (total value) of 14 Pips (K=0, 0+5+9=14). Accordingly, the height of the candlestick or bar is 25 Pips (Banker Sum)+14 Pips (Player Sum, since the Player is the loser all 14 Pips will define the lower wick), which is 39 Pips total, and represents the parameter “High.” The body is 5 Pips, the winning Banker Hand Value (BHV) or Final Value for the Banker, which begins at the 14th Pip from the bottom or “Low”. The lower end of the Pips is attributable to the player and the body extends upward for 5 Pips (of the 25 pips attributable to the banker, and the upper wick is extends 20 Pips from the body, i.e., 25 Pips (Banker Total Pips-total Pips of Candlestick attributable to winning Banker)−5 Pips (Banker winning hand final value)=20 Pips (upper wick remaining)).

In other words, the candlestick or bar height is the Player Sum Pips +the Banker Sum Pips. The body extends from the junction point (“Open”) of the Banker and Player Pips, along the winning hand wick (the Banker in this example), for a length of the winning Banker Hand Value pips (5 Pips in this example). The body is green (or gray/light colour) in color indicating a Banker win.

Turning to FIG. 4B, the Banker hand, which is the winning hand, hence the green (or gray/light colour) body, extending upward from “Open” to “Close,” has a Banker Hand Value of 7 and a Banker Sum of 7 Pips (K=0, 0+7=7). The player hand, which is the losing hand, has a Player Hand Value of 1, and a Player Sum of 21 Pips (7+5+9=21). Accordingly, the height of the candlestick or bar is 7 Pips (Banker)+21 Pips (Player, since the loser all 21 Pips will define the lower wick), which is 28 Pips total, and represents the parameter “High.” The body is 7 Pips, the winning Banker Hand Value (BHV) or Final Value for the Banker, which begins at the 21st Pip from the bottom or “Low,” the end of the Pips attributable to the player and extends upward for 7 Pips (of the 7 pips attributable to the banker), and the upper wick extends 0 Pips from the body, i.e., 7 Pips (Banker Total Pips-total Pips of Candlestick attributable to winning Banker)−7 Pips (Banker winning hand final value)=0 Pips (upper wick remaining)).

In FIGS. 5A and 5B, where the outcome is a player win, parameters are as follows:

Open(O)=previous Close(C)

High(H)=Open(O)+BS(Banker sum)

Low(L)=Open(O)−PS(Player Sum)

Close(C)=Open(O)−PHV(Banker Hand Value)

Turning to FIG. 5A, the Player hand, which is the winning hand, hence the red (or black/dark colour) body, extending downward from “Open” to “Close,” has a Player Hand Value of 9 and a Player Sum of 9 Pips (K=0, 0+9=9). The Banker hand, which is the losing hand, has a Banker Hand Value of 5, and a Banker Sum of 15 Pips (Ace (A)=1, 1+9+5=15). Accordingly, the height of the candlestick or bar is 15 Pips (Banker, since the loser all 15 Pips will define the upper wick)+9 Pips (Player), which is 24 Pips total, and represents the parameter “High.” The body is 9 Pips, the winning Player Hand Value (PHV) or Final Value for the Player, which begins at the 15th Pip from the top or “High,” the end of the Pips attributable to the Banker, and extends downward from the 15th Pip for 9 Pips (of the 9 pips attributable to the player, and the lower wick extends 0 Pips from the body, i.e., 9 Pips (Player Total Pips-total Pips of Candlestick attributable to winning Player)−9 Pips (Player winning hand final value)=0 Pips (lower wick remaining)).

Turning to FIG. 5B, the Player hand, which is the winning hand, hence the red (or black/dark colour), extending downward from “Open” to “Close,” has a Player Hand Value of 7 and a Player Sum of 17 Pips (2+9+6=17). The Banker hand, which is the losing hand, has a Banker Hand Value of 0, and a Banker Sum of 10 Pips (K=0, 3+7+0=10). Accordingly, the height of the candlestick or bar is 10 Pips (Banker, since the loser all 10 Pips will define the upper wick)+17 Pips (Player), which is 27 Pips total, and represents the parameter “High.” The body is 7 Pips, the winning Player Hand Value (PHV) or Final Value for the Player, which begins at the 10th Pip from the top or “High,” the end of the Pips attributable to the Banker, and extends downward from the 17th Pip for 7 Pips (of the 7 pips attributable to the player, and the lower wick extends 10 Pips from the body, i.e., 17 Pips (Player Total Pips-total Pips of Candlestick attributable to winning Player)−7 Pips (Player winning hand final value)=10 Pips (lower wick remaining)).

As above, in other words, the candlestick or bar height is the Player Sum Pips (17)+the Banker Sum Pips (10). The body extends from the junction point of the Banker Sum and Player Sum Pips (10th Pip from the High), along the winning hand wick (the Player in this example), for a length of the winning Player Hand Value pips (7 Pips in this example). The body is red (or black/dark colour) in color indicating a Player win.

In FIGS. 6A and 6B, where the outcome is a tie, parameters are as follows:

Open(O)=previous Close(C)

High(H)=Open(O)+BS(Banker sum)

Low(L)=Open(O)−PS (Player Sum)

Close(C)=Open(O)

Turning to FIG. 6A, there is a tie between the Banker hand and the Player hand. The tie is represented by a perpendicular line (with respect to the vertical wicks) where the “Open” and “Close,” are the same perpendicular line. The Banker hand has a final value of 7 and a total value of 17 Pips (2+9+6=17). The player hand also has a final value of 7, and a total value of 7 Pips (K=0, 0+7=7). Accordingly, the height of the candlestick or bar is 17 Pips (Banker)+7 Pips (Player), which is 24 Pips total, and represents the parameter “High.” The body is 0 Pips, since the round or session is a tie, with the perpendicular line (the “Open” and “Close” at the junction of the 7th and 8th Pip from the bottom or “Low.” The upper wick of 17 Pips, attributable to the Banker, extends upward from the perpendicular line for 17 Pips, while the lower wick of 7 Pips, attributable to the player, extends downward from the perpendicular line for 7 Pips.

Turning to FIG. 6B, there is a tie between the Banker hand and the Player hand. The tie is represented by a perpendicular line (with respect to the vertical wicks) where the “Open” and “Close,” are the same perpendicular line. The Banker hand has a final value of 0 and a total value of 20 Pips (4+9+7=20). The player hand also has a final value of 0, and a total value of 0 Pips (K=0, 10=0, 0+0+0 =0). Accordingly, the height of the candlestick or bar is 20 Pips (Banker)+0 Pips (Player), which is 20 Pips total, and represents the parameter “High.” The body is 0 Pips, since the round or session is a tie, with the perpendicular line (the “Open” and “Close”) at the 0 position or bottom or “Low.” The upper wick of 20 Pips, attributable to the Banker, extends upward from the perpendicular line, at 0 or the bottom, for 20 Pips, while the lower wick is of 0 Pips, attributable to the player, and does not exist in this candlestick or bar.

D. Example Game Played in Baccarat Rounds or Sessions

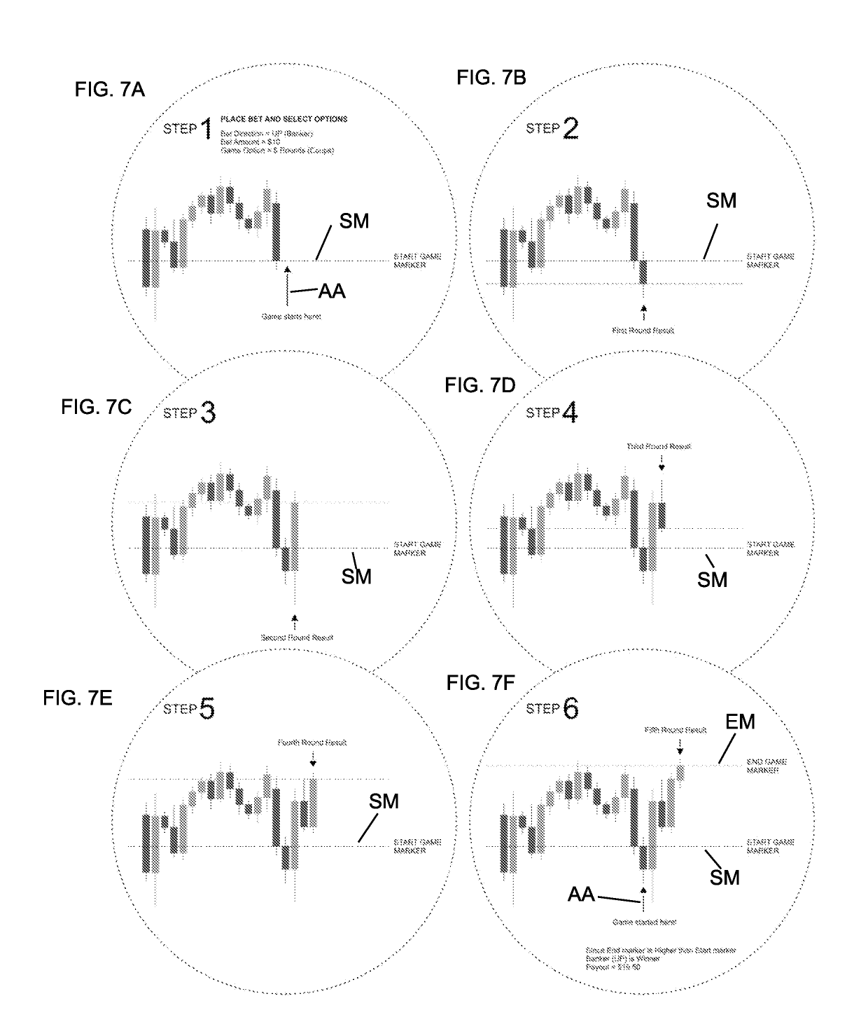

Attention is now directed to FIGS. 7A-7F, which shows a candlestick chart, and how candlesticks are added for each round or session result of a game. The candlestick charts are specific for each game, as they are created from the results of the particular game. The game shown is for five rounds or sessions, and will result in five candlesticks being added to the candlestick chart consecutively, as each round is completed. The cards for these five rounds or sessions, defining a game, are from the same pool, with a fixed number (amount) of cards. Dealt cards are not returned to the pool.

The first candlestick of the first round or session of the game extends from the Start Marker as a base, represented by a horizontally extending START MARKER line (SM) with the actual start indicated on the START MARKER line (SM) indicated by an arrow (AA), shown in FIG. 7A. The START MARKER line (SM) is aligned with the previous Close (C) of the last result candlestick (which in the example has a red/dark color body indicating a Player win and the Close adjacent the Low).

Staying in FIG. 7A, to begin, the Player bets $10 on BANKER TREND-UP, and selects a five round or session game. A START MARKER (horizontal line SM) is locked at the beginning of the game, prior to the first round or session, with an arrow (AA) on the START MARKER line indicating the point in time where the game (Round 1) will start. The START MARKER line is at the lowest point of the body of the candlestick, as the last candlestick indicated a PLAYER win. On the candlestick charts, individual candlesticks follow the Close of the candlestick for the previous round in succession.

A BANKER win is indicated by a candlestick with a green (or gray/light colour) body and the body extends upward, from either the highest point of the previous candlestick body, if the previous round win was a BANKER win, or from the lowest point of the previous body, if the previous round win was a PLAYER win. A PLAYER win is indicated by a candlestick with a red (or black/dark colour) body and the body extends downward, from either the highest point of the previous body, if the previous round win was a BANKER win, or from the lowest point of the previous body, if the previous round win was a PLAYER win.

At FIG. 7B, the first round is now complete and it was a PLAYER win. Accordingly, the body of the candlestick, the candlestick created as detailed above, is red (or black/dark colour), and extends downward, from the lowest point of the body of the preceding candlestick, i.e., the body of the candlestick of the previous round, since the previous candlestick was for a PLAYER win. Additionally, since this is the first round, the body extends downward from the START MARKER line (SM).

FIG. 7C shows the second round now complete. This second round was a BANKER win. Accordingly, the body of the candlestick, the candlestick created as detailed above, is green (or gray/light colour), and extends upward, from the lowest point of the body of the preceding candlestick, i.e., the body of the candlestick of the previous round, since the previous candlestick represented a PLAYER win.

FIG. 7D shows the third round now complete. This third round was a PLAYER win. Accordingly, the body of the candlestick, the candlestick created as detailed above, is red (or black/dark colour), and extends downward, from the highest point of the body of the preceding candlestick, i.e., the body of the candlestick of the previous round, since the previous candlestick represented a BANKER win.

FIG. 7E shows the fourth round now complete. This fourth round was a BANKER win. Accordingly, the body of the candlestick, the candlestick created as detailed above, is green (or gray/light colour), and extends upward, from the lowest point of the body of the preceding candlestick, i.e., the body of the candlestick of the previous round, since the previous candlestick represented a PLAYER win.

FIG. 7F shows the fifth round now complete. This fifth round was a BANKER win. Accordingly, the body of the candlestick, the candlestick created as detailed above, is green (or gray/light colour), and extends upward, from the highest point of the body of the preceding candlestick, i.e., the body of the candlestick of the previous round, since the previous candlestick represented a BANKER win.

With the five rounds or sessions now complete, an End Game Marker is indicated by a horizontal line (EM) along the uppermost body point of the last candlestick, with the uppermost body point selected, as the candlestick representing this final round is for a BANKER win. As the End Game Marker line (EM) is above the START MARKER LINE (SM), the BANKER is UP. Accordingly, BANKER TREND-UP bets win, PLAYER-TREND-DOWN bets loose.

Should the rounds or sessions have ended with the END GAME MARKER line (EM) below the START MARKER line (SM), this would be considered PLAYER TREND-DOWN. Also, should the rounds or sessions have ended with the END GAME MARKER line (EM) equal to the START MARKER line (SM), this would be considered a TIE. According to the rules, ties push.

F. System for Playing Baccarat

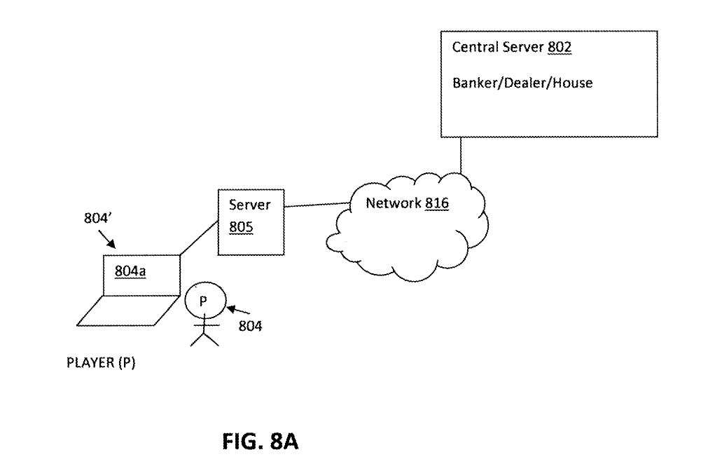

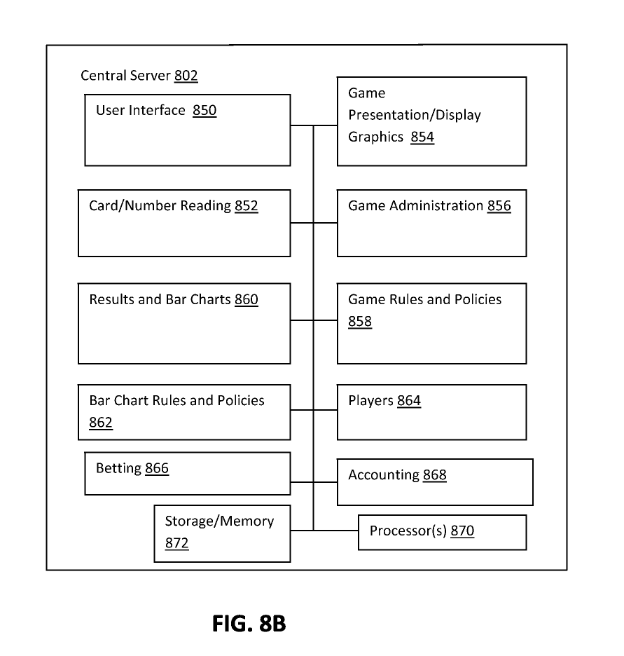

Reference is now made to FIG. 8A, which shows an operating environment for a central server 802, which defines a non-limiting exemplary control system, in accordance with some embodiments of the present invention. The server 802 functions to control the various games to be played by players, with player P 804 representative of multiple players. The server 802 controls the bar and candlestick charts associated with the game, and manages the betting on the respective games by the players, such as player P 804. Depending on the game being played, the server 802 operates as the Banker, Dealer, the house or other game administrator.

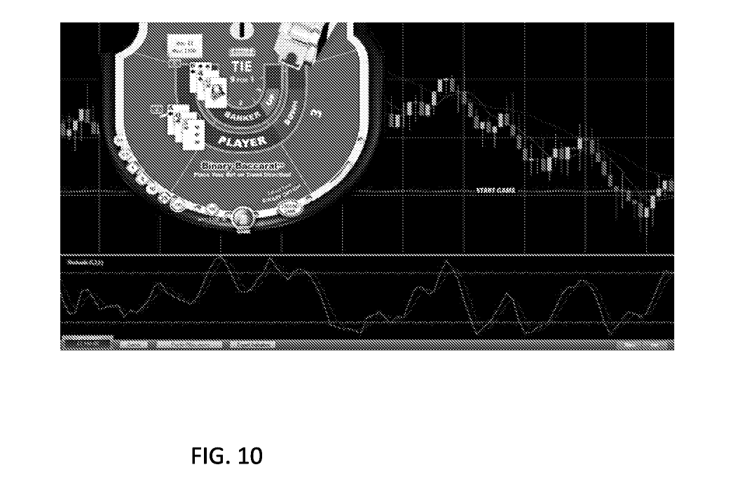

The player P has a client terminal, such as a computer 804′, e.g., personal computer, work station, lap top, desk top, tablet or computer device, such as a mobile phone, personal digital assistant and the like, with processors suitable for running the aforementioned games, and internet browsing applications, or browsers, such as Internet Explorer® from Microsoft, Firefox®, and Chrome® from Google. This computer 804′ links to a server 805. The servers 802, 805 link to a network 816, such as the Internet, or other public or wide area network (WAN) either directly or indirectly. The player P has accessed the server 802 by directing his browser to the Uniform Resource Locator (URL), for the web site and/or web page (a screen shot thereof shown in FIG. 10) for playing this baccarat game, which is hosted by the server 802.

In this baccarat game, the player P 804 plays the game against the Banker, here, the system of the server 802 serves as the Banker. The player P 804 sees a display, with a simulated table set up and a bar chart, for example, a candlestick chart, the display shown as a screen shot in FIG. 10. The display is interactive, via a mouse or other pointing device associated with the player's computer 804′, on his monitor 804a. The candlestick chart of the display is for that player, i.e., player P 804, updated to the present round or session of the game being played by that player.

The server 802, is formed of modules 850, 852, 854, 856, 858, 860, 862, 864, 866, 868 processors 870 and storage/memory 872, as shown in FIG. 8B, to which attention is now directed. The aforementioned modules, processors and storage/memory are in electronic and data communication with each other, either directly or indirectly. While single modules 850, 852, 854, 856, 858, 860, 862, 864, 866, 868 are shown, this is representative only, as each of the modules 850, 852, 854, 856, 858, 860, 862, 864, 866, 868 may be a plurality of devices. The modules 850, 852, 854, 856, 858, 860, 862, 864, 866, 868 may be hardware, software, or combinations thereof. These modules 850, 852, 854, 856, 858, 860, 862, 864, 866, 868 and all other modules described herein, may also include their own processors and or storage.

The user interface module 850 controls user, i.e., player, interaction with the system of the server 802 (also referred to hereinafter as the “system”). Player input is received via the user interface module 850, and this module 850 also outputs data for the players, associated with the server 802 via the players' participation in a game being controlled by the server 802.

The card/number reading module 852 reads the cards, when the game is a card game, and numbers, when the game is a numbers game, such as roulette. The game presentation/display graphics module 854 supports and renders all of the graphics associated with the game to the player, which are viewable via the player's monitor 804a (FIG. 8A). The Game Administration module 856 administers and manages the game being played by the player against the Banker (the server 802) as well as the bar chart displayed to the player 804. This administration and management is through, for example, stored instructions in the module 856, executed through the processors 870. game rules and policies for each game the system can play are administered and stored in the game rules and policies module 858.

The Results and Bar Charts module 860 administers results of the games and transforms these results into bars, including candlesticks, the bars and candlesticks as detailed above, for the respective bar chart or candlestick chart. The rules and policies for the bar charts, the different types of bar charts, such as candlestick charts, are administered, maintained and stored by the module 862.

A log of the players is maintained by the module 864. The betting module administers betting including, recording amounts bet, opening and closing betting periods, and establishing the times for the betting periods. Accounting module 868, which performs system accounting functions including administering, determining winning amounts, and paying bets.

The processors 870 control the operation of the system of the server 802. The processors 870 are conventional processors, such as those used in servers, computers, and other computerized devices. The processors 870 may be arranged to have a central processing unit (CPU), for controlling the system (of the server 802). For example, the processors may include x86 Processors from AMD and Intel, Xenon® and Pentium® processors from Intel, and other processors used for processing “big data.” Other processors, such as those of the modules, may be any of the aforementioned processors.

The storage/memory 872 is any conventional storage, including, for example, that usable with “big data.” This is also the case for the storage specific to the modules. This storage/memory 870 may also store machine executable instructions associated with the operation of the modules 850, 852, 854, 856, 858, 860, 862, 864, 866, 868. Also, the storage/memory 872, although shown as a single component for representative purposes, may be multiple components, and may be outboard from the server 802, and linked to the network 816.

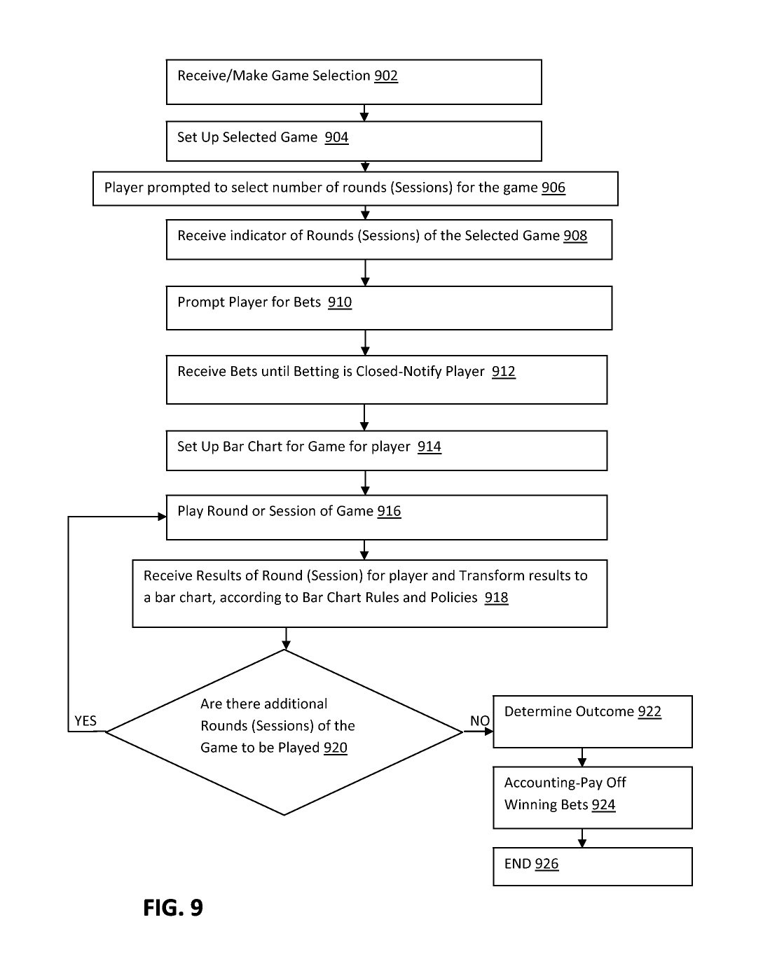

Attention is now directed to FIG. 9, which is a flow diagram detailing a process in accordance with an embodiment of the disclosed subject matter. Reference is also made to elements shown in FIGS. 8A and 8B and described above. The processes performed in this flow diagram are performed by the system of the server 802, and are typically performed automatically and in real time. While certain modules are sometimes referred to when performing a process, this mentioning is only for emphasis as other modules are also operating as well as the processors 870 and the storage/memory 872.

The process begins at block 902, where a game, such as Baccarat, is either selected by a user, e.g., player P 804, via his computer 804′or the system of the server 802 selects a game. The selected game is then set up by the system of the server 802, at block 904. The player 804 is prompted to enter the number of rounds or sessions of the now-selected game, at bock 906, and an indicator is received over the network 816 for the number of rounds or sessions of the game the player desires, at block 908. The system (server 802, playing as the Banker) may over-ride this with default values, for example, five rounds or sessions for baccarat. The system would inform the player P 804 of this default value, via a message sent to the player P 804, over the network 816, and received by the computers 804′ on the monitor 804a.

The system then prompts the player P 804, for example, via a message on the monitors 804a of his computer 804′, to place his bet for the game, at block 910. The player can make two bets-on for the baccarat game itself, and one for the trend towards the Banker or the Player, as indicated by the bar chart, for example, a candlestick chart. The player bet or bets are received by the system from the player P 804 over the network 816 until the time to bet closes, as managed by the system, in the betting module 866, at block 912. The system sets up a bar chart, for example, a candlestick chart for the individual player, i.e., player P 804, for the particular game via modules 860 and 862, with a START MARKER line (SM) and start point for the next bar, such as a candlestick, when the bar chart is a candlestick chart, at block 914. With the bar chart, for example, a candlestick chart now set up for the individual player, the candlestick chart is made accessible to that player, i.e., player P 804 via his computer 804′. The player P 804 also sees an interactive display of baccarat table with cards via his monitor 804a, the display shown in FIG. 10. This interactive display remains visible to the player until the player closes his browser, there is a system time out, the game ends, as block 926, or other closing event.

The first round or session of the game is played, via modules 854, 856, 858, at block 916. This first round or session ends when the requisite actions are complete and results for the round or session are obtained.

The received results for the player for the round or session are transformed into a bar for a bar chart, for example, a candlestick for a candlestick chart, in accordance with the rules and policies of the particular bar/candlestick chart, and a bar chart/candlestick chart for the player is created or added onto, at block 918.

The process moves to block 920, where it is determined if there are additional rounds or sessions to be played of the game. Should there be additional rounds or sessions to be played, the process returns to block 916, where it resumes from that block, playing the next round or session. Otherwise, if the round or session played was the final one of the game, the process moves to block 922, where the outcome of the rounds of the game is determined. Winning bets are paid, and an accounting is made of all winning and losing bets, by the accounting module 868, at block 924. Should the outcome be a TIE win (tie), this is also subject to an accounting by the accounting module 868. The process ends at block 926.

BLACKJACK

A. Rules

Each hand will play out a hand of Blackjack based on Simple House Rules (hit all totals 16 or lower). The hand that is closest to 21 will win. If a player bets on either Player or Dealer and the outcome is a Push, the bet amount is not lost and is considered a push as in standard Blackjack. Each hand is considered to be a round or session and will be represented by a single bar, such as a candlestick. A BlackJack game will be a certain number of rounds or sessions. The cards for these rounds or sessions, defining a game, are from the same pool, with a fixed number (amount) of cards. Dealt cards are not returned to the pool.

B. Wicks and Body of Candlestick for Candlestick Chart

For Blackjack, the candlesticks are generated in a different manner. The body of the candlestick is determined by the difference between the winning hand value and the losing hand value, multiplied by the number of cards dealt for the winning hand.

The lengths of the upper wick and the lower wick extending from the body are determined from the hand value and the number of cards dealt for the Player and Banker respectively. The respective wick heights are determined by hand total value divided by the number of cards dealt.

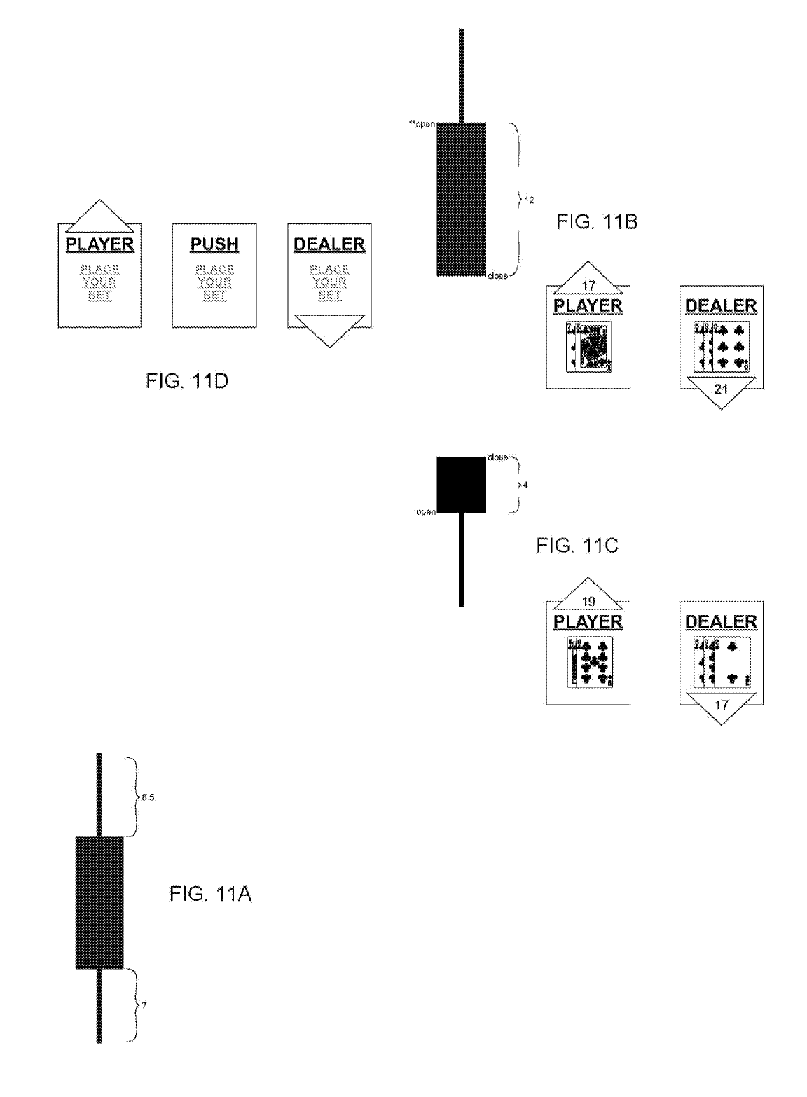

In the example as shown in FIGS. 11A and 11B, the wicks and body of a candlestick are determined, based on the dealer winning with a 21 from three cards, while the player had a 17 from two cards. The wick on the topside of the candlestick relates to the player's final score, while the bottom wick refers to the dealer's final score. In FIG. 11A, for example, the top wick is 8.5 Pips, based on a player's final score of 17 from two cards, expressed as 17/2=8.5 Pips. The bottom wick is based on the dealer's final score of 21 from three cards, expressed as 21/3=7 Pips. For the body, as shown in FIG. 11B, in this example, the dealer is the winner. The difference between the dealer and the player is 4, or 21 (dealer)−17 (player). The dealer drew three cards total, so the body of the candlestick is 12 Pips in height, expressed as the difference 4 multiplied by 3 dealer drawn cards or 4×3=12 Pips, the body length. Additionally, in Blackjack, dealer wins have a body of one color, while player wins have a body of another color.

FIG. 11C details how the body of the candlestick is determined in the case of a player win. Here, the player won with a 19 with two cards drawn, while the dealer lost with a 17 from three cards drawn. The upper wick, representative of the player, is 9.5 Pips, 19/2, while the lower wick representative of the dealer, is 5.66 Pips, 17/3. The body of the candlestick is in the color of the player win, and is determined by the difference between the player score and the dealer score, 19-17=2, multiplied by 2, the total number of cards drawn by the winner player. Accordingly, the body length is 4 Pips, or 2×2=4 Pips.

The Bar chart, for example, a candlestick chart, for the individual player playing the Blackjack game is made like that for the Baccarat candlestick chart as shown in FIGS. 7A-7F and described above.

C. Play and Set Up

The system is similar to that of server 802, as shown in FIGS. 8A and 8B and described above, as is the environment in accordance with FIG. 8A, where the player P 804 plays against a dealer or the house, which is the system of server 802. The process of play is similar to that shown by the flow diagram of FIG. 9 and as described above.

HI LO

A. Rules

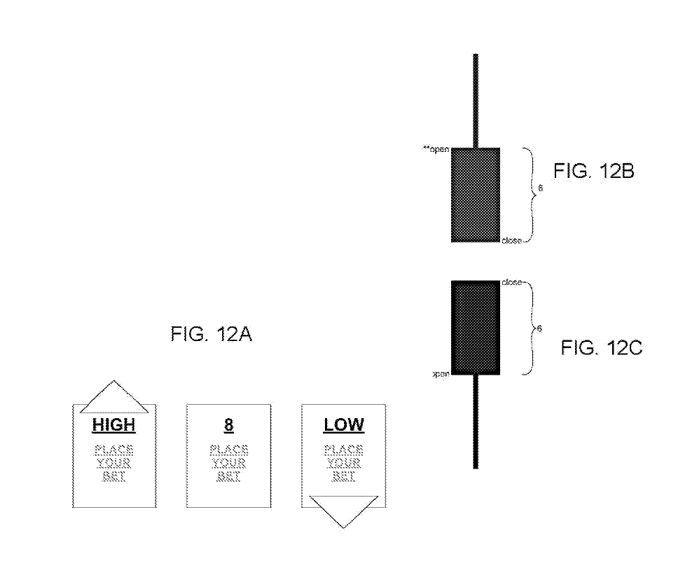

Before any cards are dealt, players place their bets in one of three boxes, HIGH (over 8), 8, or LOW (under 8), as shown in FIG. 12A, and as would appear on the monitor of a computer of each player. Once betting is complete, one card is dealt face up. The “LOW” bet wins when the value of the card is 2, 3, 4, 5, 6, or 7. The 8 bet wins when the card value is 8. The “HIGH” bet wins when the card is a 9, 10, Jack (11), Queen (12), King (13) and Ace (14). Losing bets are forfeited to the dealer and winning bets are paid according to a pay table. If a player bets HIGH or LOW and the card dealt is an 8, this is considered a Tie and the bet amount is not lost. A pay table may be as follows. LOW and HIGH bets pay 1:1 less house commission. An 8 bet pays 12:1 less house commission. Each dealt card is considered to be a round or session and will be represented by a single bar, such as a candlestick. A HI LO game will be a certain number of rounds or sessions. The cards for these rounds or sessions, defining a game, are from the same pool, with a fixed number (amount) of cards. Dealt cards are not returned to the pool.

B. Candlesticks For Candlestick Charts

The body of a candlestick represents the difference between the dealt card and the number 8, the middle point. As shown in FIG. 12B should a 2 card be the dealt card, the body of the candlestick is 6 Pips in height, expressed as 8 (the midpoint)−2 (the dealt card)=6 Pips. The body (e.g., red in color) is at the lower end of the wick, due to a low card (below 8) having been dealt. As a low card was dealt, it is a different color (e.g., red) than a high card (e.g., black), which will now be explained.

As shown in FIG. 12C should an Ace (14) or high card (value greater than 8) be dealt, the body of the candlestick is 6 Pips in height, expressed as 14 (value of the ace)−8 (the midpoint)=6 Pips. The body (e.g., black in color) is at the upper end of the wick, due to a high card (above 8) having been dealt.

When an 8 card has been dealt, there is only a dash for the body, since the body is 0 Pips in height, expressed as 8 (card dealt)−8 (the midpoint)=0 Pips.

C. Candlestick Chart

The candlestick chart is such that black candlesticks, indicative of HIGH (high) card wins move upward, while red candlesticks, indicative of LOW (low) card wins move downward. 8 cards are represented by a dash on the candlestick chart. The candlestick chart is made for the individual player playing the HI LO like that for the Baccarat candlestick chart as shown in FIGS. 7A-7F, and described above.

D. Play and Setup

The system is similar to that of server 802, as shown in FIGS. 8A and 8B and described above, as is the environment in accordance with FIG. 8A, where the player P 804 plays the HI LO game against a dealer or the house, which is the system of server 802. The process of play is similar to that shown by the flow diagram of FIG. 9 and as described above.

ROULETTE

A. Rules And Play

The roulette wheel referenced here is a 37 slot roulette wheel, with 0 green and 1-36 in red and black. Other roulette wheels may also be used. In the present invention, games based on Roulette provide many different new game options as described below, including High/Low, Even/Odd, or Black/Red. The present invention however also provides a novel means for displaying the historical results of a traditional number based Roulette game, via the generation of a candlestick or bar chart. Each ball drop is considered to be a round or session and will be represented by a single bar, such as a candlestick. In the binary game version as further described below, a Roulette game will be a certain number of rounds or sessions, established, for example, by the players at the time the bets are placed. In the FX game version as further described below, a Roulette game will finish when a certain result is reached regardless of the number of rounds. The house or the game administrator is the system of the server 802.

B. Body of Candlesticks

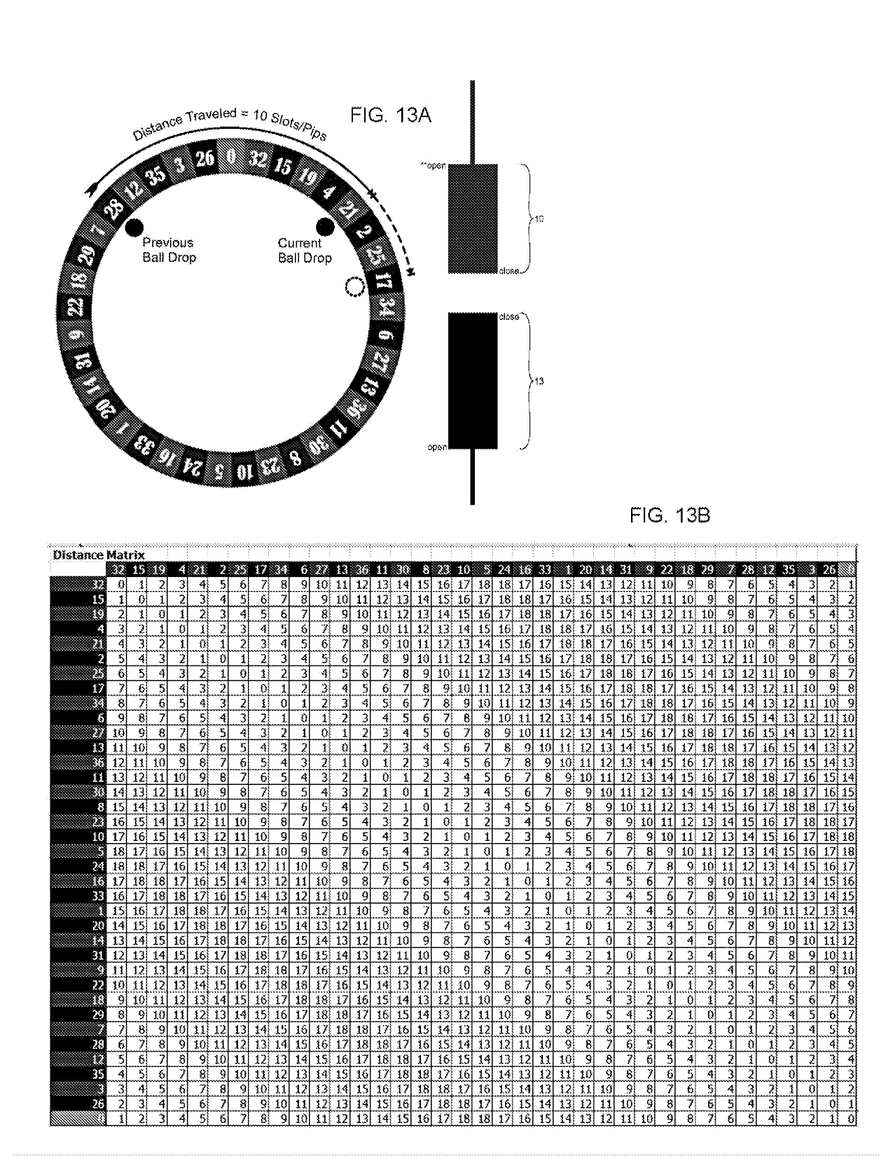

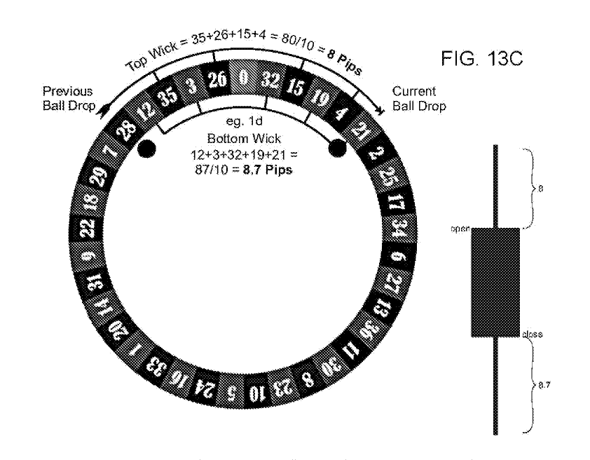

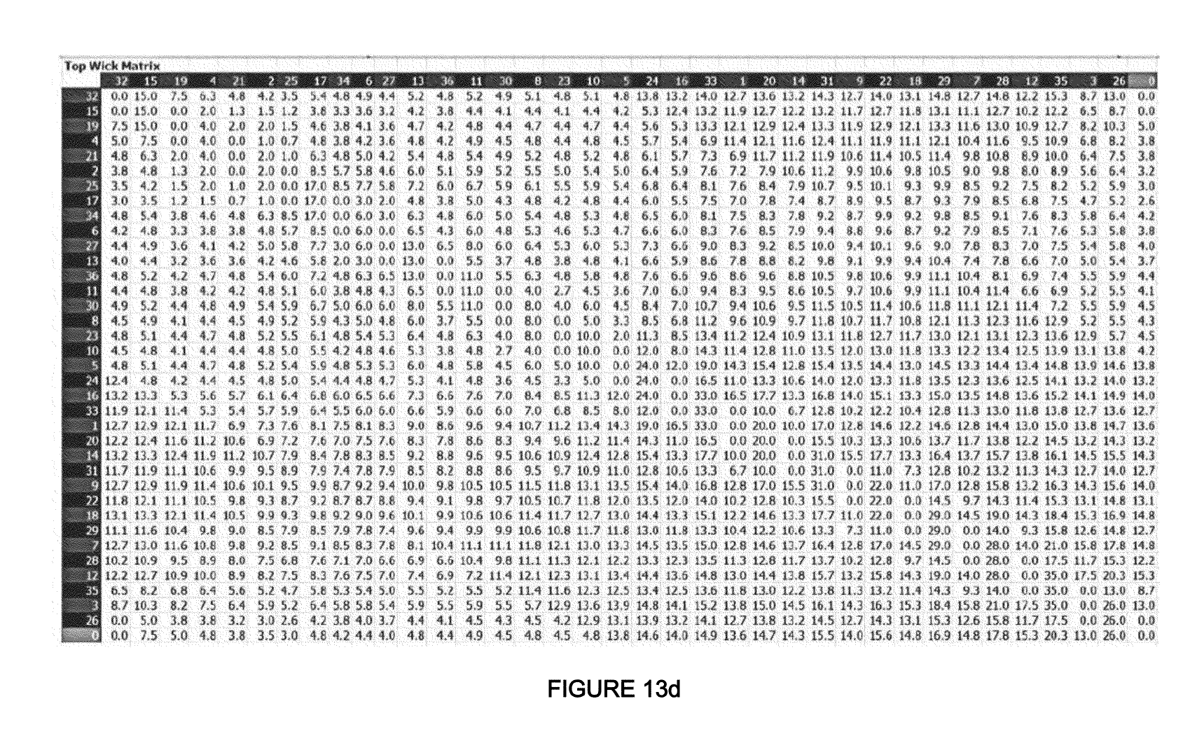

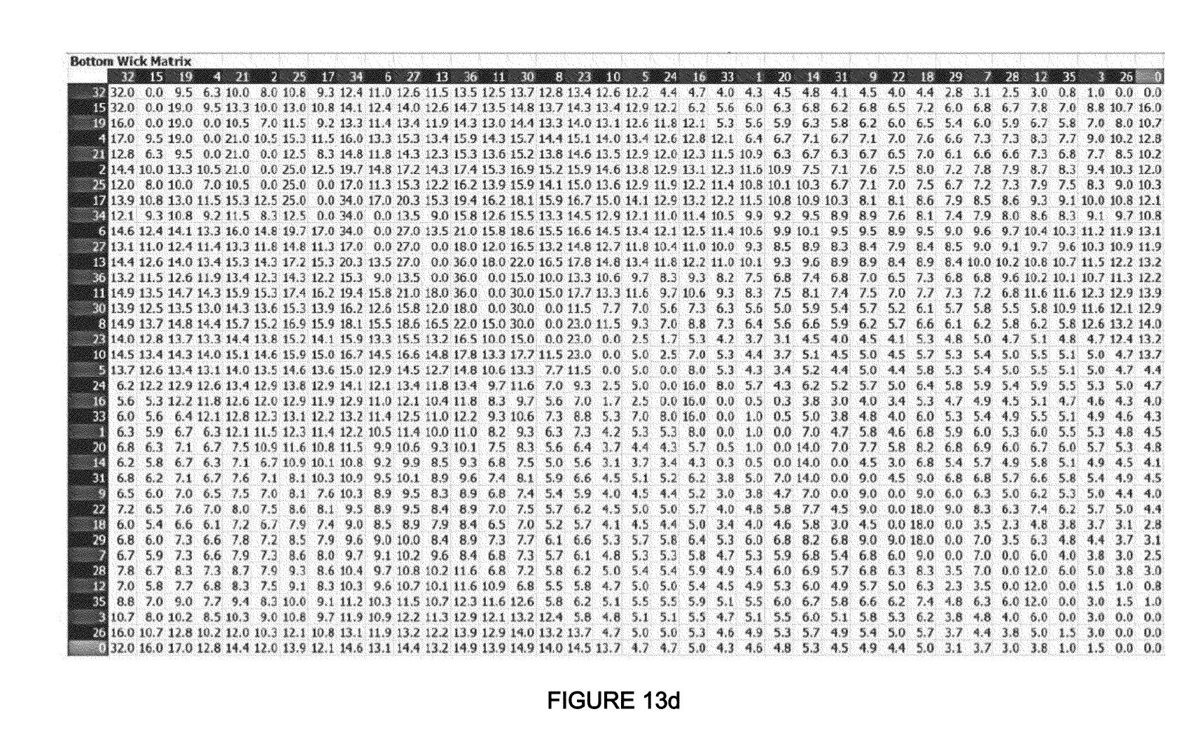

In any of the game options, the height of the body of a candlestick represents the distance the ball has traveled (in number of slots on the Roulette wheel) since the previous number. For example, in FIG. 13A, the distance traveled (in number of slots) from the previous ball drop 28 to the current ball drop at 21, based on the shortest slot distance, which is 10 slots (in accordance with the distance matrix of FIG. 13B). Accordingly, the body of the candlestick is 10 Pips.

Distances are always in the range 0 (same as the last result) to 18 (the two positions on the opposite side of the wheel). So if the last result were red 21, and the next were black 15, the candlestick body height would be 3 because these two numbers are 3 positions apart on the roulette wheel. If the current result is a zero. the candlestick body is also zero height irrespective of the distance to the last result.

C. Direction/Orientation of the Candlestick Body

Gigure 14 shows a chart showing the nominated up/down direction of the candlestick bodies from the previous Close, for each of the selected game options High/Low, Even/Odd, or Black/Red. The results High (19-36), Even, or Black are designated as Trend-Up and the candlestick body will extend up from the previous Close. The results Low (1-18), Odd, or Red are designated as Trend-Down and the candlestick body will extend down from the previous Close. Alternatively, these designations can be reversed if desired.

As the equivalent result (High/Low, Even/Odd, or Black/Red) differs for each number result, the resulting charts from each option will be different. For example, a number result 32 Red will produce a Trend-Up candlestick body for High/Low and Even/Odd game options but a Trend-Down candlestick body for a Black/Red game option.

Chart colouring is upward candlesticks are green, while downward candlesticks are red on a black background.

In the example of FIG. 13A, as 21 is red, the candlestick body is red and will extend down from the previous Close, with a red body below the upper wick. Now, if the current ball drop was 17, a black number, the body of the candlestick would be 13 Pips as 17 black is 13 slots away from 28 black. As 17 is black, the body is green and will extend up from the previous Close, above the lower wick.

D. Wicks Of The Candlesticks

The wick values and lengths do not affect game outcomes and are regarded as cosmetic only. The wicks of the candlestick are based on the example of FIG. 13C and the Wick Matrices of FIG. 13D. The ball movement of interest is from 28 black to 21 red.

As in the example shown in FIG. 13C, the top or upper wick is the sum of all black slots (number values) between the previous drop, 28 black, and the current drop, 21 red (excluding the previous drop slot, 28 black and including the current drop slot, 21 red) divided by the distance traveled, which in the example is expressed as 35+26+15+4=80. As 10 slots were traveled, 80 is divided by the 10 of the ten slots traveled, with a result of 8, for an upper wick height of 8 Pips. For the bottom or lower wick, this is the sum of all red slots (values) between the previous drop, 28 black, and the current drop, 21 red (excluding the previous drop slot, 28 black and including the current drop slot, 21 red) divided by the distance traveled, which in the example is expressed as 12+3+32+19+21=87. As 10 slots were traveled, 87 is divided by the 10 of the ten slots traveled, with a result of 8.7, for a lower wick height of 8.7 Pips. A tall wick on the upper side of a candlestick body thus indicates a high number region pertaining to the color black (black numbers). A tall wick on the lower side of a candlestick body indicates a high number region pertaining to the color red (red numbers).

E. Candlestick Chart

The resultant candlestick chart is built like the candlestick charts detailed above, for each individual player. Green/Black winning candlesticks always moving up and red winning candlesticks always moving down. Each candlestick, created as discussed above, represents a single ball drop, which as discussed above, corresponds to a single round or session, with a certain number of these rounds or sessions constituting a game. As described above, the resulting charts from each option (High/Low, Even/Odd, or Black/Red) will be different.

The method of forming the candlesticks as describe above are useful by themselves for showing historical results of Roulette games for High/Low, Even/Odd, or Black/Red betting options of the game. Users can view these charts and may be able to ascertain a trend from the charts to assist with their betting. At the least, the charts provide an attractive display of results that entices the users to study the trends and bet accordingly.

New Methods of Gaming

Candlestick charts are used in foreign exchange trading to help understand the seemingly erratic movement of currency pairs, and to allow prediction of future trends. The games presented in the present invention make use of the candlestick charts for entertainment. The example below refers to Roulette and Baccarat games. It will be appreciated however that the new methods of gaming are applicable to any other games of chance for which the candlesticks charts can be formed.

Instead of a live currency market feed, the input is a traditional casino table game such as roulette or baccarat. The resulting candlestick charts, due to the method of formation of the candlesticks and the method of forming the charts as described above, show much of the same movement seen in forex markets charts.

The present invention provides new methods of gaming using a traditional casino game and the formation of candlestick charts according to the above.

A player chooses a source game (baccarat, roulette), a chart game type for roulette (black/red, high/low, or even/odd charts), and a time scale (tick—one second per game), minute, 5 minute). These different game options (as described below) provide result charts that look slightly different and offer different challenges. The aim of each game however remains, which is to predict whether the trend will be Trend-Up or Trend-down.

The aim for the player to pick the future Trend-Up or Trend-down. This can be at the end of a fixed (selected) number of games (binary game version). Alternatively, as in FX markets, a different game option is which of two limits is crossed first (FX game version). An Early Exit offer is available every turn so the player can use strategy to attempt to do better than the offered game.

The idea of adding a strategy component to roulette will interest players, as roulette has always been a game of chance alone. The use of candlestick charts and a continuous stream of games with history gives much more information than the traditional results of the last 15 games. The charts show more action and provide entertainment. Candlestick charts are interesting because of the body of knowledge available in reading their trends.

The present invention provides at least four new possible games as follows:

| | Based on Roulette | Based on Baccarat |
|---|---|---|
| Binary game: | Binary Roulette | Binary Baccarat |
| pick the trend up or down | with Early Exit | with Early Exit |
| bet resolved after | | |
| selected game rounds | | |
| FX games: | Roulette FX | Baccarat FX |
| foreign exchange limits | with Early Exit | with Early Exit |
| up or down | | |
| bet resolved when a | | |
| limit is reached | | |

Binary Games

In the Binary games, a Player selects the number of rounds to play in advance for each game, for example 60 Baccarat rounds for each betting game. A candlestick chart is produced, where each candlestick shows the result of each round, as per the method described above. If a Player bets Trend-Up, then a final result (e.g. End Game Marker in FIG. 7) above where the Player started (e.g. Start Game Marker in FIG. 7) after 60 rounds is a win for that game. A final result below the Start Game marker is a loss, and a net zero result is a tie (Tie is a push, and the bet is refunded).

In Binary Baccarat the ‘banker’ wins are up, and ‘player’ wins are down. Since banker wins more often than player in a single game, the win odds reflect this. Trend-Up bets pay 0.95 to 1, while Trend-Down bets pay 1:1, matching single game traditional baccarat pays.

Binary Roulette Game

Game Description

The traditional roulette wheel is used: alternating black and red numbers from 1 to 36 with a green zero. Instead of betting on the outcome of the wheel directly, Binary Roulette allows bets on the outcome of games in the following way.

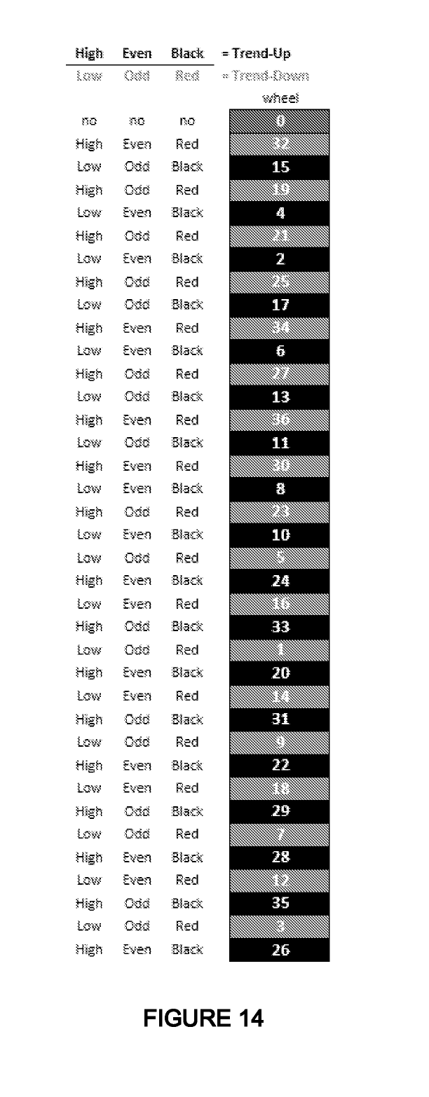

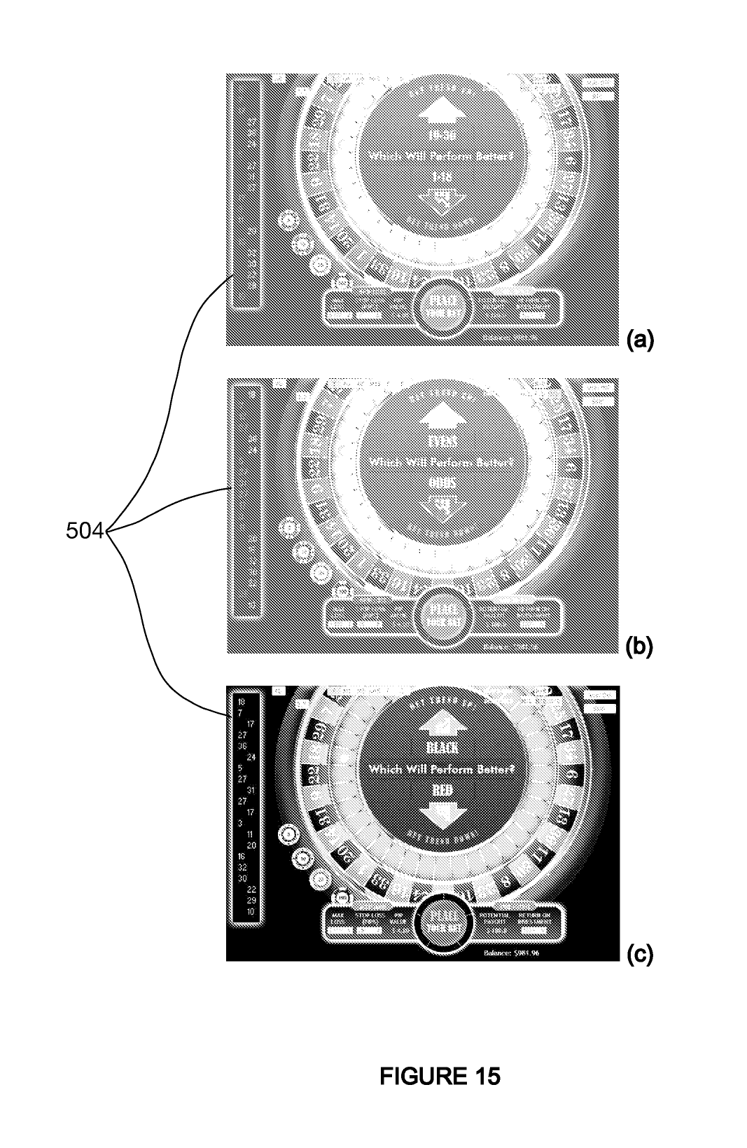

FIG. 15 shows three possible betting selection screens. Players select one of three candlestick charts generated from sequential roulette games: (a) High/Low, (b) Even/Odd, or (c) Black/Red. Each chart uses the same roulette results, but interprets them in a different way. As can be seen from the historical number results bar 504 on the left side of each betting screen, the corresponding result (whether red/dark or green/light) for each number result can differ based on the game mode chosen as per the table in FIG. 14. The number results in each of the bars 504 are the same yet the corresponding results can vary, which varies the movement of the candlestick bodies (up or down) and thus varies the resulting chart.

Every game generates a candlestick body with a height ranging from −18 to +18. The candlestick chart displays the sum of all candlesticks as a history of individual game results. The player bets on whether the chosen chart will Trend-Up or Trend-Down over a selected number of games.

Betting is on the final result after a predetermined number of games. The return of each game is set as for traditional roulette: 97.3%, so if a player bets up and the final pips are above where the player started, the player is paid 0.973 to 1. If the final pips are lower, the player loses their bet. If the final pips are the same as where the player started then it is a PUSH and the player gets their bet back.

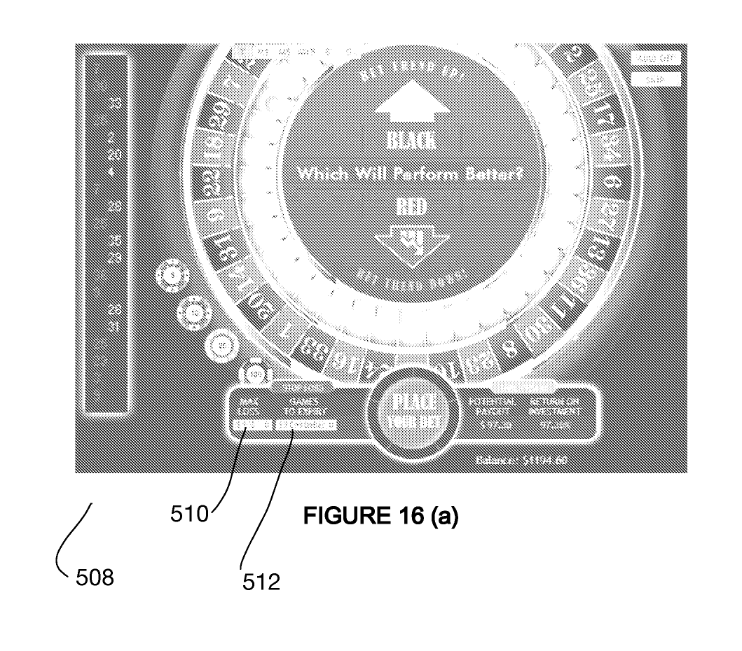

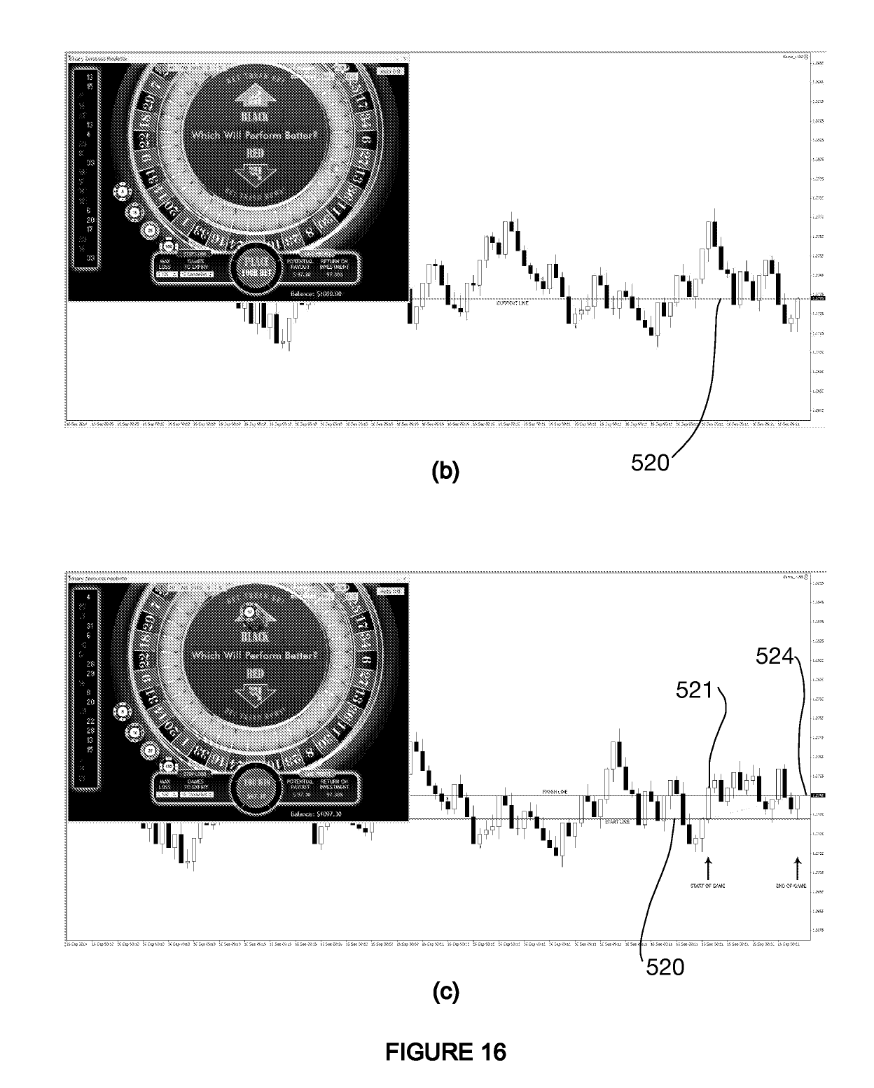

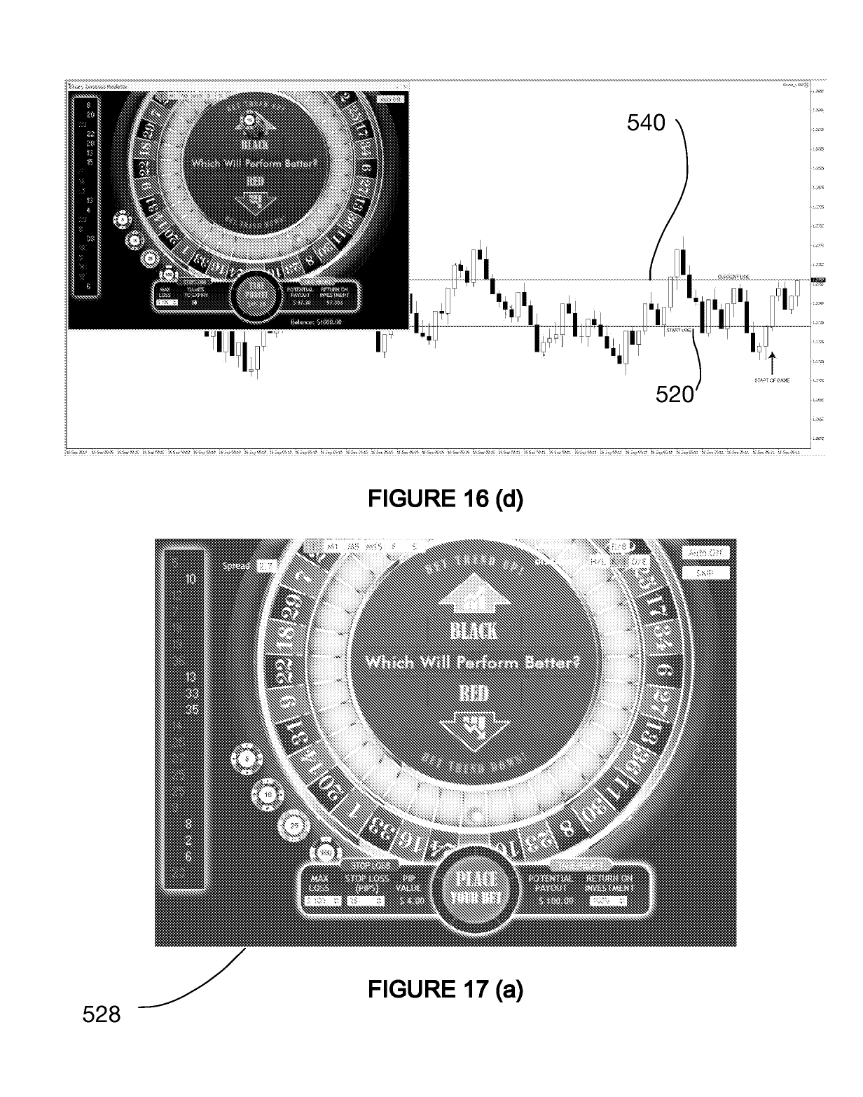

FIG. 16 shows an example. FIG. 16(a) shows a betting screen 508 for a binary black/red game. The speed of individual games can be controlled by the user, but is normally 1 game per second.

Betting Options:
Bet amount is selectable at option 510: min $5.00, max $500.00 in the example.
Game length is selectable at option 512: min 1 candlestick, max 60 candlesticks (on each chart scale)

Bet Type:

| | | | |
|---|---|---|---|
| Trend-Up option: | Black | High (19-36) | Even (non-zero) |
| Trend-Down | Red | Low (1-18) | Odd (non-zero) |
| option: | | | |

Display Options:
Auto off: When auto is off the player clicks ‘Spin’ for each new game.
Auto on: With auto on, games are continuous 1 per second (or as set by the player).
Game speed: min 1 game per 5 seconds, max 1 game per second (default).

Chart Options:

| | | 1 minute | 5 minutes | 15 minutes |
|---|---|---|---|---|
| | | (1 | (1 | (1 |
| Chart scale: | Tick chart | candlestick | candlestick | candlestick |
| (assuming 1 | (every game | every 60 | every 300 | every 900 |
| game per | shown) | games) | games) | games) |
| second) | (option 514) | (option 515) | (option 516) | (option 517) |
| Max games: | 60 | 3,600 | 18,000 | 54,000 |

In the example shown, the player has opted to play 15 games, with a bet of $100, for a Trend-Up (black) result). As shown in FIG. 16(b), the game starts at the Close of the last candlestick as indicated by the Start Marker line 520. The first candlestick 521 of the first round of the game extends from the Start Marker 520 as a base. After 15 games, as shown in FIG. 16(c) the End Marker line 524 is above the SM line 520 indicating a Trend-Up result and a win for the player.

Early Exit Option

The player can opt to take the Early Exit offer at any time during a game. Candlestick charts are ideal for showing trends, and the player is allowed to take an Early Exit at any time if he feels that the trend has turned against him. Early Exit offers are updated each game based on the chance of winning from the current position. The player is paid the value shown if they take the offer, and the game ends. If the player is losing prior to taking the Early Exit option, the option taken is called a Stop Loss at which the player loses part of their maximum bet. FIG. 16(d) shows an example at which the player is winning and can take an early profit exit.

FX Games

FX games use a ‘target based’ expiry instead of a predetermined number of game rounds. The player selects limits above and below the initial position (e.g. Start Game Marker in FIG. 7), and the game ends when either of the limits is crossed. A candlestick chart is also produced, where each candlestick shows the result of each round, as per the method described above. The limits directly indicate profit or loss. If the player bets up, he wins if the upper limit is crossed first, but loses if the lower limit is crossed first. All FX wins are paid even money (1 to 1).

Roulette FX Game

The traditional roulette wheel is used: alternating black and red numbers from 1 to 36 with a green zero. The candlestick charts (High/Low, Even/Odd, or Black/Red) are generated and displayed in a similar manner as above. The player bets on whether the chosen chart will Trend-Up or Trend-Down.

Instead of betting on the result after a fixed number of games as per the binary version, Roulette FX bets set two limits (in the style of foreign exchange trading). If the player bets Trend-Up, the player wins if the upper limit is reached, but loses if the lower limit is reached first. If the player bets Trend-Down, the player wins if the lower limit is reached first, but lose if the upper limit is reached first. The game ends as soon as either limit is reached. Roulette FX games have no fixed length.

With equal limits up and down, Roulette FX pays 1:1 on wins. Limits do not have to be symmetrical however. Halving the win limit doubles the chances of winning. So the payouts offered for this option are also halved. Similarly, to receive double odds, the win limit can be doubled compared to the loss limit and the chances of winning are reduced. For a single stop loss limit, win limits of 25%, 50%, 100%, 150% and 200% are offered.

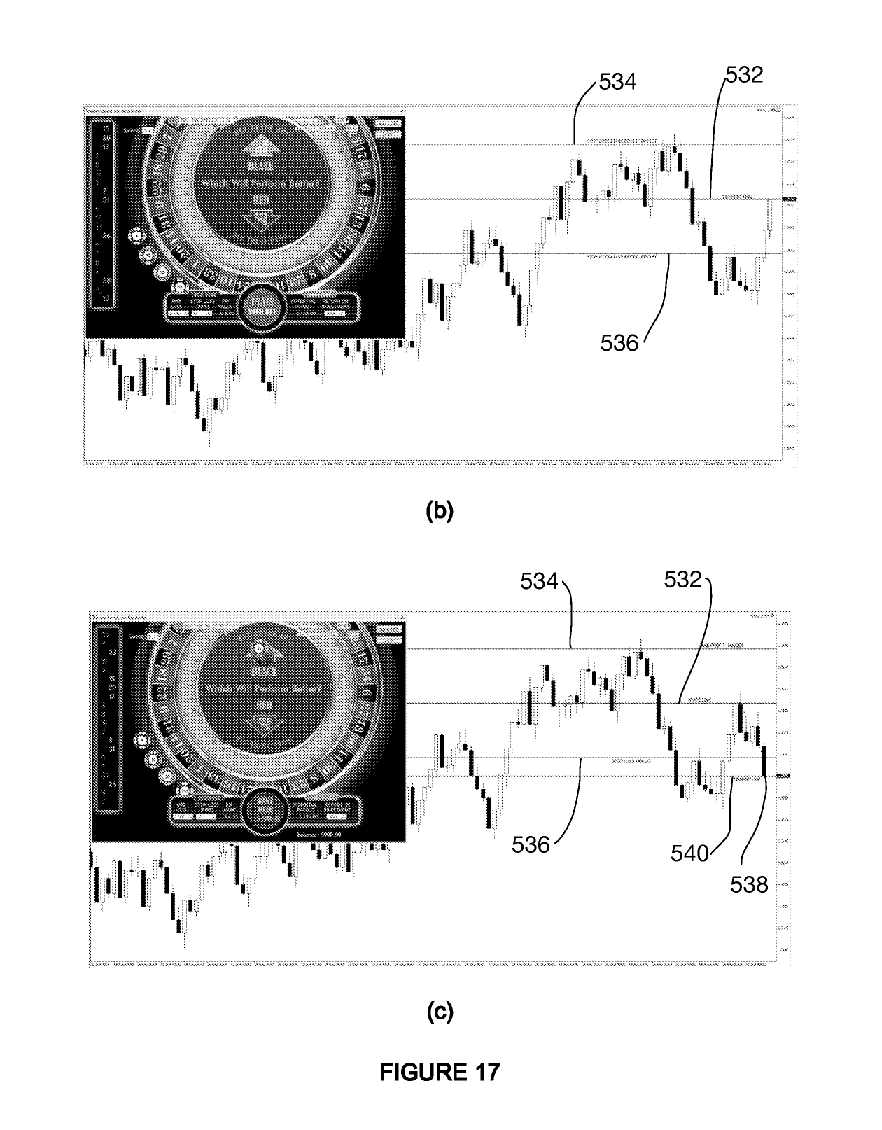

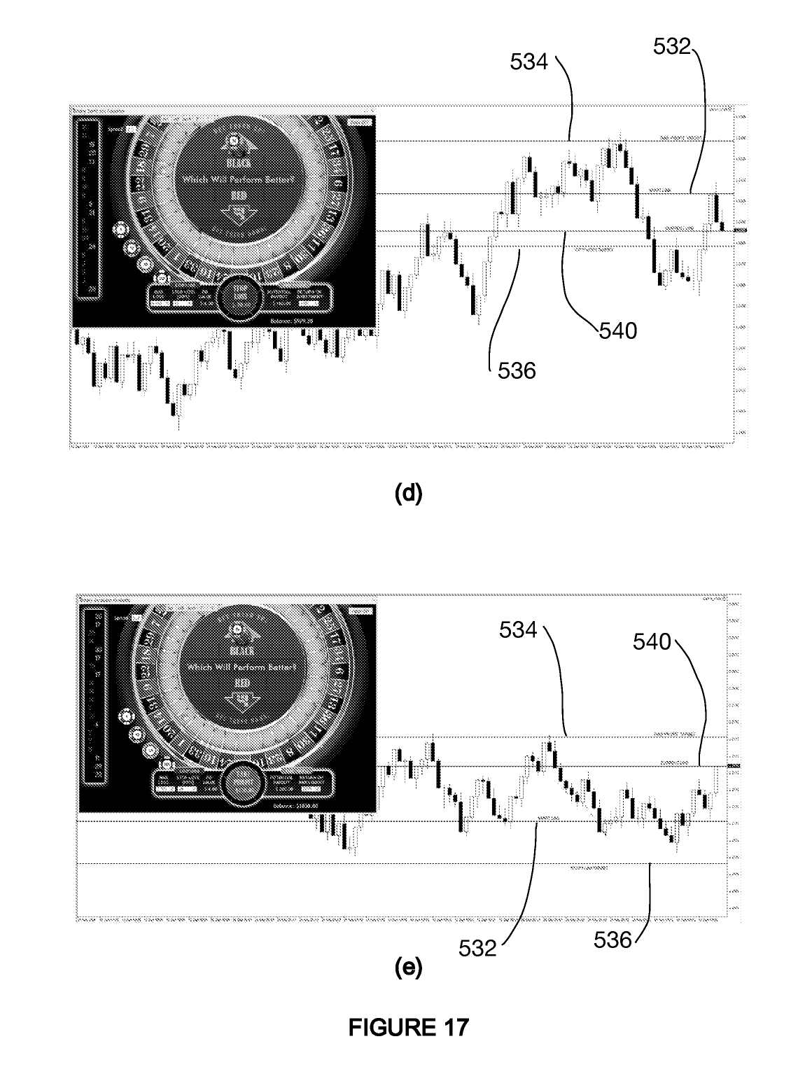

FIG. 17 shows an example. FIG. 17(a) shows a betting screen 528 for an FX black/red game. Betting options:
Bet amount: min $5.00, max $500.00
Bet type:

| | | | |
|---|---|---|---|
| Trend-Up option: | Black | High (19-36) | Even (non-zero) |
| Trend-Down | Red | Low (1-18) | Odd (non-zero) |
| option: | | | |

Game limit ranges:

| Chart selected: | 1 second | 1 minute | 5 minutes |
|---|---|---|---|
| Min stop loss | 25 pips | 100 pips | 200 pips |
| Typical games | 7 | 76 | 288 |
| Max stop loss | 75 pips | 200 pips | 500 pips |
| Typical games | 44 | 288 | 1,740 |

Skewed limits and pays:

| Win limit variation | 25% | 50% | 100% (normal) | 150% | 200% |
|---|---|---|---|---|---|
| Fair odds payout | x 0.25 | x 0.5 | x 1 | x 1.5 | x 2 |

In the example, the player has opted to bet $100, for 25 Pips, for a Trend-Up (Black bet). FIG. 17(b) shows a start screen, with the Starting Marker line 532, Take Profit target line 534 and a Stop Loss line 536. As shown in FIG. 17(c), after five games, the Stop Loss line 536 was crossed by the last candlestick 538, as also shown by the Current (or End Game) line 540. This results in a player bet loss.

Early Exit Feature

Candlestick charts are ideal for showing trends, and the player is allowed to take an Early Exit at any time if he feels that the trend has turned against him. The Early Exit offer is updated each game based on the chance of winning (and losing) from the current position. The player is paid the value shown (or lose) if they take the offer. FIG. 17(d) shows an example. The player has opted to bet Trend-Up. The Current Line 540 is closer to the Stop Loss line 536, and the Stop Loss offer 544 is −$70.00.

FIG. 17(e) shows a 200% bet example. The Take Profit target line 534 is twice the distance from the Starting Marker line 532 as the Stop Loss line 536. If the Take Profit target line 534 is reached first, the player wins double their bet. As the Current Line 540 is closer to the Take Profit target line 534, a winning Take Profit option 552 is presented.

Thus, another feature of FX games is that limits may not be symmetrical. For Trend-Up bets, the lower limit is called a ‘stop loss’ and the upper limit is called ‘take profit’. If the take profit limit is half the stop loss value, the win can occur twice as often, but the payout would be only 50% (odds of 1 to 2). In the reverse, if the take profit limit is double the stop loss value, a win payout would be 200% (odds of 2 to 1).

Early Exit Feature

An Early Exit is a feature of both Binary games and FX games. As the chart progresses, players have an option to leave the game early for a price. Early Exit offers are made in actual currency rather than as odds. Each game round Early Exit offers are updated based on the chances of the player winning from the current position.

The whole idea of adding a strategy component to roulette and baccarat will interest players. These two games have always been games of chance alone. The use of candlestick charts and a continuous stream of games with history is reminiscent of the old baccarat scoring system. Candlestick charts are interesting because of the body of knowledge available in reading their trends.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, non-transitory, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to +/−10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

Whilst preferred embodiments of the present invention have been described, it will be apparent to skilled persons that modifications can be made to the embodiments described.

For example, the candlestick bodies can be formed in a different manner, such as fractions of the values described above. For example, in Roulette, the body height can be 1/10th of the number of slots traveled. In the values described above, the maximum height per candle in a single round of roulette is 18 pips, but by using a ( 1/10th) fraction of the value, the maximum height per candle in a single round of roulette is 1.8 pips. In Baccarat, the body height can be 1/10th of the winning hand value. And so the maximum height per candle in a single round of Baccarat would be 0.9 pips. The invention can also be used with other games such as poker, where the game is configured as Dealer vs. Player.

1. A computer-implemented method for displaying results in a game of chance as a chart, the method comprising:
(a) transforming a result of a round of the game into a candlestick for a chart,
(b) adding the candlestick for said round to said chart,
(c) repeating steps (a) and (b) for each round of the game.

2. The method of claim 1, wherein each candlestick comprises a body having a height extending from a parameter Open to a parameter Close.

3. The method of claim 2, wherein each candlestick to be added is positioned laterally adjacent the preceding candlestick, and the parameter Open of a candlestick to be added is horizontally aligned with the parameter Close of the preceding candlestick.

4. The method of claim 3, wherein each body extends vertically and oriented in an upwards or downwards direction relative to the parameter Close of the preceding candlestick, the direction being determined by the winning result of the game.

5. The method of claim 2, wherein each candlestick or bar body can include upper and/or lower wicks extending from the body, the lower wick extending from a parameter Low and the upper wick extending from a parameter High.

6. The method of claim 2, wherein, for a Baccarat game, the height of the body is equal to a pip value of a winning Banker or Player hand.

7. The method of claim 5, wherein, for a Baccarat game, a total candlestick wick height is the sum of pip values of the Player card values plus the sum of pip values of the Banker card values, wherein the body extends from the junction point of the Banker and Player pips and along the winning hand wick for a length of the winning hand value pips.

8. The method of claim 6, wherein the body is provided with a respective predetermined color to indicate a Banker or Player win.

9. The method of claim 4, wherein, for a Baccarat game, the body extends upwardly for a Banker win and downwardly for a Player win.

10. The method of claim 2, wherein, for a Roulette game, the height of the body is determined by the number of slots a Roulette ball has traveled on the Roulette wheel from the previous number result to the present number result.

11. The method of claim 10, wherein if the present number result is zero, the candlestick body has zero height.

12. The method of claim 4, wherein, for a Roulette game, the game options of High/Low, Even/Odd, or Black/Red are provided, wherein the body extends upwardly for results High, Even, or Black, and the body extends downwardly for results Low, Odd, or Red.

13. The method of claim 12, wherein the body is provided with a respective predetermined color to indicate a High/Even/Black or Low/Odd/Red result.

14. A computer-implemented method of gaming, the method comprising:
displaying the results of rounds in a game of chance as a chart according to the method of claim 4,
a player selecting a number of rounds to play of the game,
a player selecting to bet on trend-up or trend-down from a starting level being level with a Close of the preceding candlestick body prior to game start,
determining a finishing level at game finish being level with a Close of the final candlestick body after the number of rounds, and
wherein the vertical position of the finishing level relative to the starting level determines a win or loss for the Player.

15. The method of gaming of claim 14, further comprising the step of: having an early exit feature, wherein a part profit or part loss is offered to the Player to terminate the game prior to game finish.

16. The method of gaming of claim 15, wherein the part profit or part loss is calculated from the relative position between the starting level and a current level being level with a Close of the latest candlestick body.

17. A computer-implemented method of gaming, the method comprising:
displaying results of rounds in a game of chance as a chart according to the method of claim 4,
a player selecting to bet on trend-up or trend-down from a starting level being level with a Close of the preceding candlestick body prior to game start,
a player selecting upper and lower limits of a trend chart,
wherein a candlestick body crossing either the upper or lower limit terminates the game and determines a win or loss for the Player.

18. The method of gaming of claim 17, further comprising the step of having an early exit feature, wherein a part profit or part loss is offered to the Player to terminate the game prior to game finish, the part profit or part loss is calculated from the relative position between the starting level and a current level being level with a Close of the latest candlestick or bar body.

19. A computer-implemented method for displaying at least one result in a game of chance, the method comprising:
transforming a result of a round of the game into a candlestick for a chart.

20. The method of claim 19, wherein the candlestick comprises a body having a height extending from a parameter Open to a parameter Close, the height of the body being determined by the winning result of the game.
